(19) United States
(12) Patent Application Publication
(10) Pub. No.: US 2025/0386317 A1
(43) Pub. Date: Dec. 18, 2025

(54) SYSTEMS AND METHODS FOR NEW RADIO POSITIONING BASED NON-TERRESTRIAL NETWORK USER EQUIPMENT LOCATION

(71) Applicant: APPLE INC., Cupertino, CA (US)

(72) Inventors: Fangli Xu, Beijing (CN); Haijing Hu, Los Gatos, CA (US); Alexander Sirotkin, Hod Hasharon (IL); Naveen Kumar R Palle Venkata, San Diego, CA (US); Yuqin Chen, Beijing (CN); Ralf Rossbach, Munich (DE); Peng Cheng, Beijing (CN); Zhibin Wu, Los Altos, CA (US); Ping-Heng Kuo, London (GB)

(21) Appl. No.: 18/878,718

(22) PCT Filed: Jul. 20, 2023
(86) PCT No.: PCT/US2023/070569

§ 371 Date: Dec. 24, 2024

Related U.S. Application Data
(60) Provisional application No. 63/369,825, filed on Jul. 29, 2022.

(51) Int. Cl. H04W 64/00; G01S 5/04; G01S 5/14; H04B 7/185; H04W 24/10

(52) U.S. Cl. CPC H04W 64/00; G01S 5/04; G01S 5/14; H04B 7/1851; H04W 24/10

(57) ABSTRACT

Systems and methods for radio access network (RAN)-based user equipment (UE) location determination in non-terrestrial networks (NTNs) are discussed herein. Round trip time (RTT) mechanisms, uplink angle of arrival (UL-AoA) mechanisms, and/or uplink time difference of arrival (UL-TDOA) mechanisms may be used between a UE and one or more NTN payloads operating a serving cell of a base station to provide the base station data used to determine a location of the UE. In some example, a single uplink (UL) reference signal is used in conjunction with multiple payloads, while in others multiple UL reference signals sent during different measurement instances are used with a single payload. The base station may not be dependent on certain core network (CN)-related functionality (e.g., an LTE positioning protocol (LPP) and/or an NR positioning protocol A (NRPPa)) to make this determination. In some embodiments, a determined location is used to verify a UE-reported location.

### TECHNICAL FIELD

This application relates generally to wireless communication systems, including wireless communication systems implementing non-terrestrial network (NTN) communication mechanisms.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 502.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an NTN architecture of a wireless communication system, according to an embodiment.

FIG. 2 illustrates a diagram of an NTN architecture according to an embodiment.

FIG. 3 illustrates a diagram of an NTN architecture according to an embodiment.

FIG. 4 illustrates a diagram of an NTN architecture according to an embodiment.

FIG. 5 illustrates a flow diagram for location service support by NG-RAN that uses an LMF.

FIG. 6 illustrates a table of supported UE positioning methods in NR.

FIG. 7 illustrates signaling between a UE and a base station/TRP attendant to a multi-RTT procedure, according to an embodiment.

FIG. 8 illustrates a diagram for using distances from various base stations/TRPs to arrive at an estimated location of a UE, according to an embodiment.

FIG. 9 illustrates a diagram corresponding to the use of UL-AoA and/or UL-TDOA to locate a UE, according to embodiments disclosed herein.

FIG. 10 illustrates a flow diagram of a base station triggered/controlled RTT positioning mechanism framework, according to an embodiment.

FIG. 11A illustrates a flow diagram showing an example use of a base station triggered/controlled RTT positioning mechanism, according to an embodiment.

FIG. 11B illustrates a diagram corresponding to an example use of a base station triggered/controlled RTT positioning mechanism.

FIG. 12 illustrates a method of a base station, according to an embodiment.

FIG. 13A illustrates a flow diagram showing an example use of a base station triggered/controlled RTT positioning mechanism, according to an embodiment.

FIG. 13B illustrates a diagram corresponding to an example use of a base station triggered/controlled RTT positioning mechanism.

FIG. 14 illustrates a method of a base station, according to an embodiment.

FIG. 15 illustrates a diagram corresponding to an example use of a base station triggered/controlled UL-AoA and/or UL-TDOA positioning mechanism.

FIG. 16 illustrates a method of a base station, according to an embodiment.

FIG. 17 illustrates a method of a base station, according to an embodiment.

FIG. 18 illustrates a diagram corresponding to an example use of a base station triggered/controlled UL-AoA and/or UL-TDOA positioning mechanism.

FIG. 19 illustrates a method of a base station, according to an embodiment.

FIG. 20 illustrates a method of a base station, according to an embodiment.

FIG. 21 illustrates an example architecture of a wireless communication system, according to embodiments disclosed herein.

FIG. 22 illustrates a system for performing signaling between a wireless device and a RAN device connected to a core network of a CN device, according to embodiments herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Non-terrestrial networks (NTNs) refer to networks (or segments of networks) using airborne and/or space-borne vehicle(s) to perform communications.

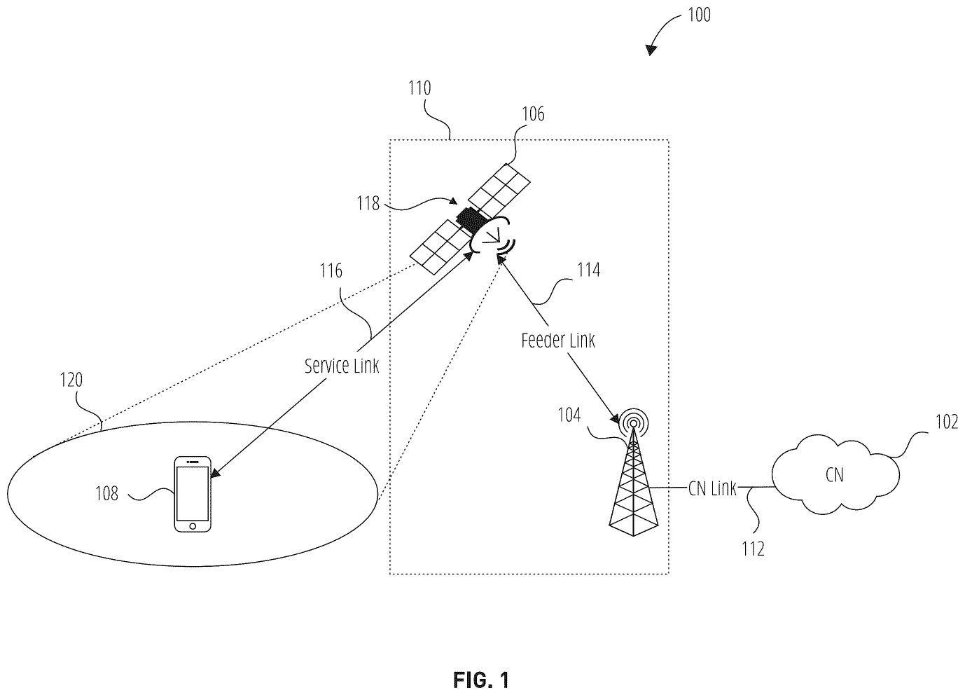

FIG. 1 illustrates an NTN architecture 100 of a wireless communication system, according to an embodiment. The NTN architecture 100 includes a core network (CN) 102, a base station 104, a vehicle 106 having a payload 118, and a UE 108. The base station 104, and the payload 118 of the vehicle 106 may be included in a RAN 110.

In some embodiments, RAN 110 includes NG-RAN, the CN 102 includes a 5GC, and the base station 104 includes a gNB or a next generation eNB (ng-eNB). In such cases, the CN link 112 connecting the CN 102 and the base station 104 may include an NG interface.

In the NTN architecture 100, the payload 118 of the vehicle 106 is a network node of the RAN 110. The payload 118 may be equipped with one or more antennas capable of operating (e.g., broadcasting, facilitating communications of, etc.) a cell 120 of the RAN 110 as instructed/configured by the base station 104. The base station 104 communicates (e.g., via a non-terrestrial gateway (not shown)) with the payload 118 of the vehicle 106 over a feeder link 114. The UE 108 may be equipped with one or more antennas (e.g., a moving parabolic antenna, an omni-directional phased-array antenna, etc.) capable of communicating with the payload 118 via a Uu interface on a cell 120 of the RAN over a service link 116. Herein cells (such as the cell 120) that are provided by a payload of an NTN vehicle may be referred to as “NTN cells.” It is also noted that a payload of an NTN may be sometimes referred to herein as an “NTN payload.”

The NTN architecture 100 illustrates a “bent-pipe” or “transparent” satellite based architecture. In such systems, the payload 118 transparently forwards data between the base station 104 and the UE 108 using the feeder link 114 between the base station 104 and the payload 118 and the service link 116 between the payload 118 and the UE 108. The payload 118 may perform radio frequency (RF) conversion and/or amplification in both uplink (UL) and downlink (DL) to enable this communication.

In the embodiment shown in FIG. 1, the base station 104 is illustrated without the (express) capability of terrestrial wireless communication directly with a UE. However, it is contemplated that in embodiments, such a base station using a non-terrestrial gateway to communicate with the payload 118 could (also) have this functionality (either with the UE 108 or with another (unillustrated) UE).

The NTN architecture 100 illustrates a vehicle 106 that is a space-borne satellite. In such cases, it may be that the vehicle 106 is a low earth orbit (LEO) satellite, a medium earth orbit (MEO) satellite, a geosynchronous earth orbit (GEO) satellite, or a high earth orbit (HEO) satellite. It is also noted that vehicles other than satellites may be used in NTN networks. For example, the vehicle 106 could instead be a high altitude platform station (HAPS) (such as, for example, an airship or an airplane).

In some cases, NTN networks may be useful to address mobile broadband needs and/or public safety needs in areas that are unserved/underserved by terrestrial-based network elements. Some such example cases include maritime applications, airplane connectivity applications, railway applications, etc.

It may be that in some cases an NTN network supports/uses, for example, LEOs and GEOs, with further implicit compatibility for supporting HAPSs and air-to-ground (ATG) scenarios. Further, an NTN network may focus on frequency division duplex (FDD) mechanisms, with time division duplex (TDD) mechanisms being applied for relevant scenarios, such as for HAPS, ATG, etc.

Some NTN networks may use earth-fixed tracking areas for a defined areas that do not change corresponding to any movement of a payload of the NTN.

It may also be that UEs have the capability of determining their own location (e.g., via global navigation satellite systems (GNSSs) such as global positioning system (GPS), Galileo GNSS, etc.) and further of communicating that location information to the base station (e.g., via a payload).

UE that may be used in NTN networks may include, but are not limited to, handheld devices operating in FR1 (e.g., power class 3 devices) and/or very small aperture terminal (VSAT) devices with external antenna at least in FR2.

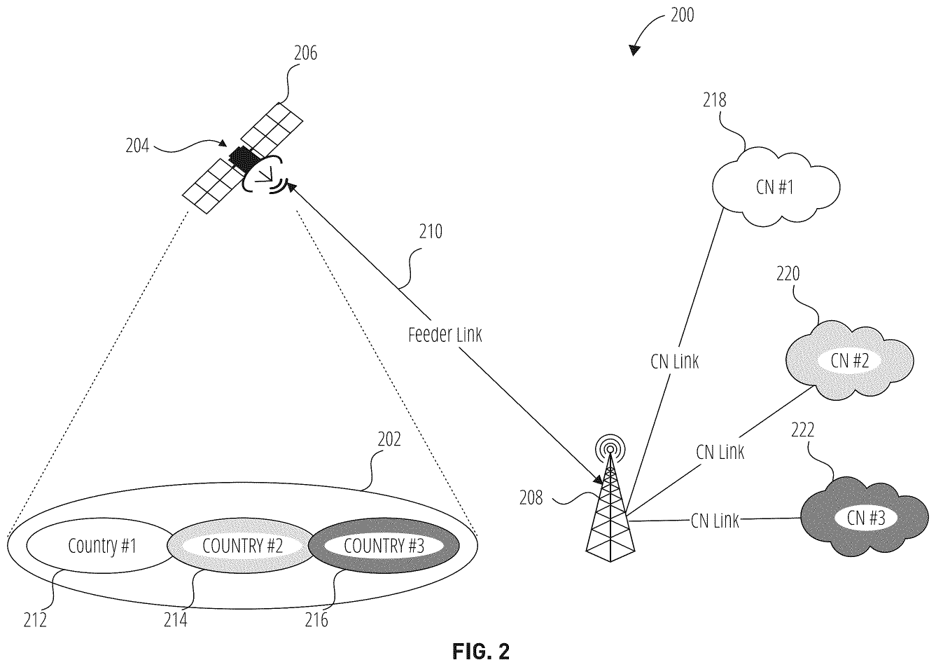

FIG. 2 illustrates a diagram 200 of an NTN architecture according to an embodiment. An NTN cell 202 (and/or a beam used within a cell) may cover a large area (e.g., due to the height of the payload 204 on the vehicle 206) relative to cell areas of cells/beams of cells broadcast by terrestrial-based equipment. For example, as illustrated, the NTN cell 202 covers multiple different geographical areas (including at least the country #1 212, the country #2 214, and the country #3 216).

An NTN may be able to broadcast multiple public land mobile networks (PLMNs) in a single cell, with one or more PLMNs corresponding individually to individual geographical areas within the cell. These PLMNs may be operated by individual CNs corresponding to each of the geographical areas. It is noted that examples herein may use different countries as the geographical areas that correspond to particular PLMNs/CNs. While this may reflect some real-world applications, it will be understood that other geographical areas (including, e.g., geographical areas not necessarily delineated along political boundaries) could exist within an NTN cell and be treated as described herein.

In the diagram 200 of FIG. 2, PLMN correspondence is illustrated with shading. Accordingly, it may be understood with reference to the diagram 200 that a first PLMN is operated by the first CN 218 for the country #1 212 via the base station 208 through the use of the feeder link 210, a second PLMN is operated by the second CN 220 for the country #2 214 via the base station 208 through the use of the feeder link 210, and a third PLMN is operated by the third CN 222 for the country #3 216 via the base station 208 through the use of the feeder link 210.

Multiple tracking area codes (TACs) per PLMN (up to, e.g., 12) may be used in a single NTN cell (such as the NTN cell 202). A UE communicating within the wireless communication system (e.g., according to the NTN architecture of the diagram 200) may not be expected to perform a registration procedure if one of the currently broadcast TACs belongs to the UE's present registration area.

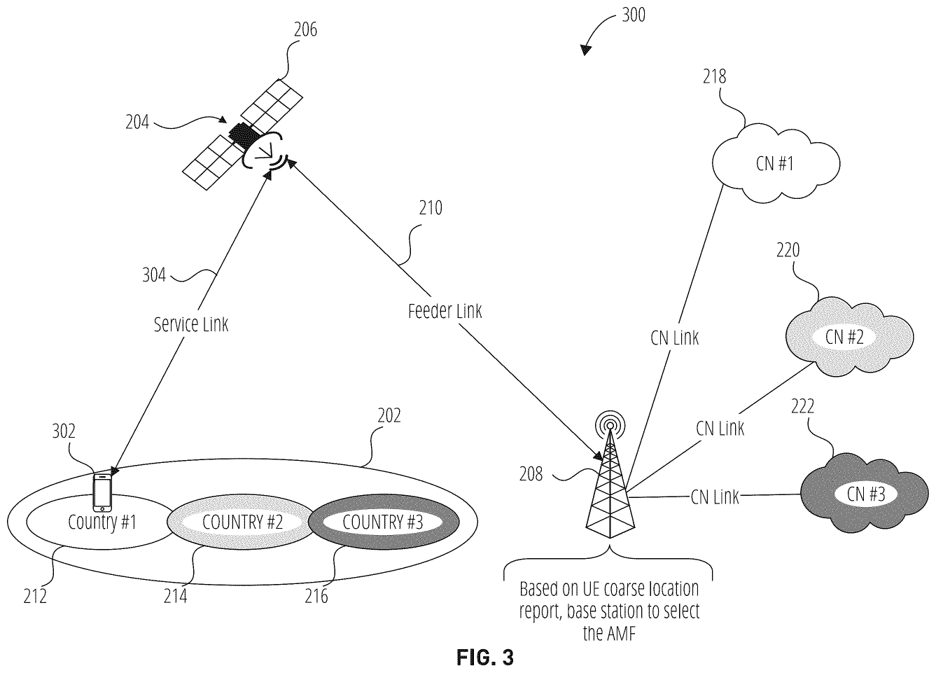

FIG. 3 illustrates a diagram 300 of an NTN architecture according to an embodiment. The diagram 300 may include elements of the diagram 200 as indicated, as these are described herein, with elements of the flow diagram 300 that remain analogous to similar elements of the diagram 200 being numbered again as in the diagram 200.

Further, the diagram 300 illustrates a UE 302 that is located in country #1 212 and that communicates with the base station 208 via signaling with the payload 204 of the vehicle 206 via a service link 304, as illustrated.

The UE 302 may provide a location report to the base station via the payload 204. For example, the UE may determine its own location in terms of GNSS coordinates, within an accuracy of, for example, around two kilometers (km) and report this value to the base station 208. This may be an example of a “coarse location report” as used herein.

Based on the location report, the base station 208 may perform access and mobility management function (AMF) selection (e.g., may select an AMF of one of the first CN 218, the second CN 220, and the third CN 222 to control access and/or mobility for the UE 302). In cases where the base station has been configured to ensure that the selected AMF serves the country where the UE is located, the base station will select the AMF of the CN that operates the PLMN for the country in which the UE is located. In the case of the diagram 300, this means that the base station 208 will select the AMF of the first CN 218 because the UE's location report identified the UE as being located in country #1 212, and access and/or mobility for the UE 302 will accordingly be managed by the AMF of the first CN 218.

It may be that the base station uses the reported location of the UE to select the AMF in this manner in order to comply with regulatory requirements (e.g., that ensure that the access of the UE is accurate, private, reliable, and of acceptable latency). Examples of regulated features where it may be important to ensure that the UE is connected to a CN (e.g., an AMF of the CN) that corresponds to is present location (in order to comply with the regulation) include, but are not limited to, cases where the UE makes an emergency call, cases where a lawful intercept of communications is to occur per the applicable law in the geographical area where the UE is located, cases where public warnings are to be issued to UEs in the geographical area where the UE is located, enforcement of data retention policies based on cross-border situations, and/or for accurate charging and billing based on the geographical area where the UE is located. Accordingly, development of systems and methods enabling a wireless communication system to locate UEs in a reliable manner such that corresponding policy that applies to their operation depending on their location and/or context may be accurately determined is beneficial.

To meet such regulatory requirements, an NTN network may enforce the correspondence between operation under a particular PLMN and the present location of the UE in a geographical area corresponding to that PLMN. This may be accomplished in at least some cases by causing the network to verify the location reported by the UE during mobility management and session management procedures.

Such verification is useful because it can be the case that a UE reported location (as nominally determined at the UE using, e.g., GNSS and then reported to the base station, as described) could be erroneous. For example, a user of the UE or a third party may maliciously configure the UE to report an incorrect location (with the purpose of, for example, being incorrectly assigned within the wireless communication system to a geographical area that, e.g., is licensed for certain content that is not licensed in the actual geographical area of the UE, has a cheaper charging and billing than that associated with the actual geographical area of the UE, etc.). As another example, interference may cause the UE reported location to be incorrect (e.g., the UE may incorrectly determine its location when GNSS signals have high interference).

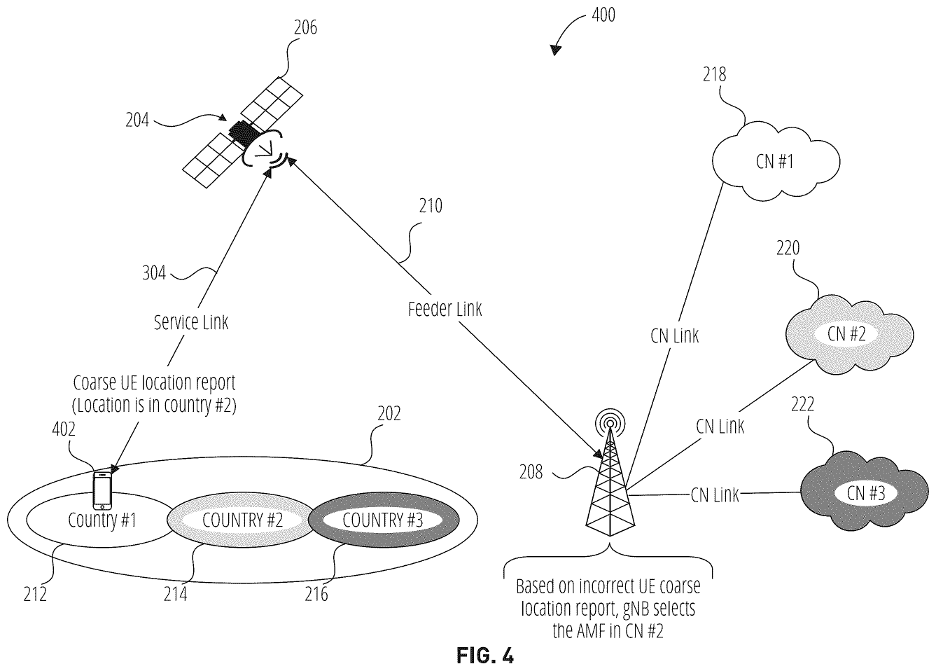

FIG. 4 illustrates a diagram 400 of an NTN architecture according to an embodiment. The diagram 400 may include elements of the diagram 200 as indicated, as these are described herein, with elements of the flow diagram 400 that remain analogous to similar elements of the diagram 200 being numbered again as in the diagram 200. The diagram 400 illustrates an example of a scenario involving a UE 402 that may occur in cases where a location reported by the UE 402 is not verified using a RAN-based UE location verification mechanism.

As may be seen, the UE 402 is presently located in the country #1 212. The UE 402 may send, to the base station 208, via the payload 204, a location report that inaccurately indicates that the reported location of the UE is in country #2 214. In response, the base station 208 selects the second CN 220/the AMF in second CN 220 corresponding to country #2 214 to provide service to the UE 402. Among other issues, this allows the UE 402 to acquire information specific to country #2 214 via the NTN connection (e.g., public warning system (PWS) information for country #2 214, media content licensed for the country #2 214, etc.), to be operated according to the charging policy of country #2 214, etc., outside of any national regulations and/or other operational constraints which should apply to the use of the UE 402 in the country #1 212.

Accordingly, systems and methods disclosed herein may relate to manners in which the RAN may be enabled to independently perform verification on the location report provided by the UE to the network, in order to ensure that the UE is associated with the correct CN-related features/functions (e.g., corresponding to the correct PLMN corresponding to an actual location of the UE), such as the AMF of the CN which controls access functions for the UE. Systems and methods disclosed herein may operate to perform this function in a manner that overcomes inherent difficulties that arise due to the large relative size of a single NTN cell and the corresponding potential of having multiple differently-treated geographical locations sited therein.

In some NR wireless communication systems, an NR positioning mechanism may be triggered by a location management function (LMF) and/or an evolved serving mobile location center (E-SMLC), which may be located in a CN. Positioning specific protocols in an NR position framework may include an LTE positioning protocol (LPP) that is terminated between a UE and a positioning service (e.g., an LMF) and/or an NR positioning protocol A (NRPPa) that carries information between NG-RAN and an LMF.

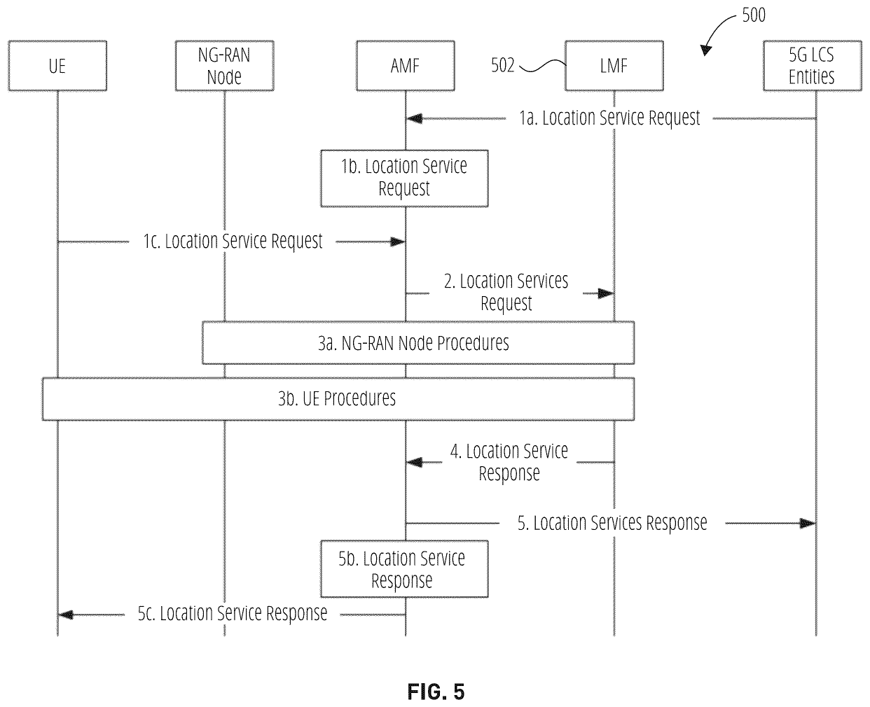

FIG. 5 illustrates a flow diagram 500 for location service support by NG-RAN that uses an LMF 502.

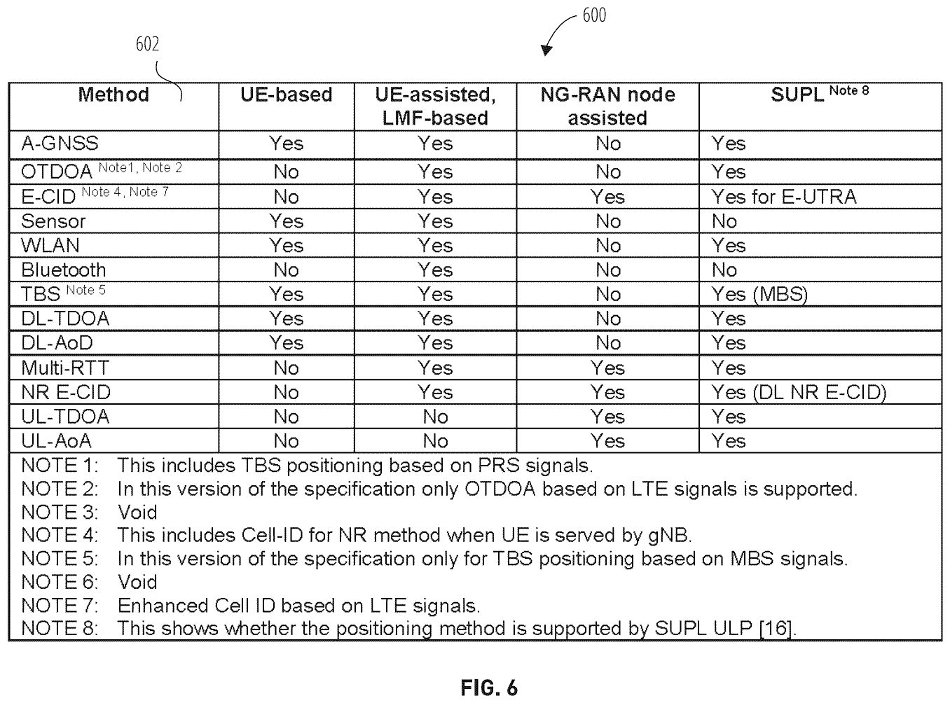

FIG. 6 illustrates a table 600 of supported UE positioning methods 602 in NR.

Round trip time (RTT) mechanisms using multiple RTTs (multi-RTT) (e.g., such as multiple-cell-based RTT mechanisms) may be used in some NR networks for determining a location of a UE within the RAN. One advantage of such RTT mechanisms is that there is no requirement for stringent synchronization among base stations that participate.

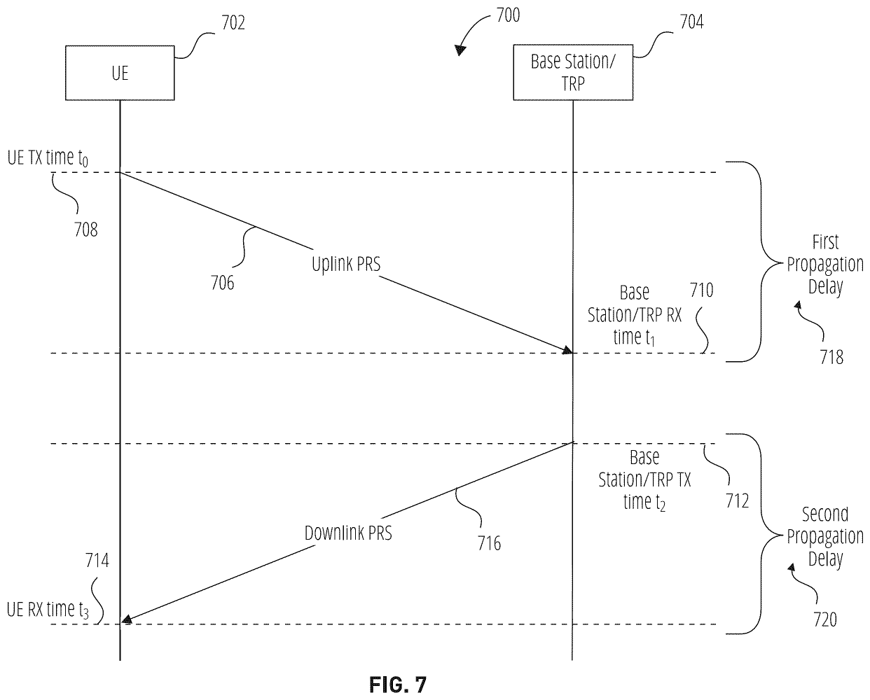

FIG. 7 illustrates signaling between a UE 702 and a base station/transmission reception point (TRP) 704 attendant to a multi-RTT procedure, according to an embodiment. A multi-RTT procedure may be initiated by either a UE or a base station. The initiating device (e.g., in the case, take the UE 702) transmits, for example, a sounding reference signal (SRS) (e.g., that is understood to be a type of (UL) reference signal that is an UL positioning reference signal (UL-PRS) 706), which may be received at one or more base stations/TRPs, including the base station/TRP 704. The UE records the time to 708 at which the UL-PRS 706 was sent. The SRS may be understood to be a type of UL reference signal transmittable by the UE 702, and may in some embodiments be a positioning specific SRS.

The base station/TRP 704 receives the UL-PRS 706 at the time t₁ 710 (and it records this time). Other base stations/TRPs perform similar operations (each receiving the UL-PRS 706 and recording its own independent time t₁).

Each base station/TRP sends a downlink positioning reference signal (DL-PRS) to the UE 702 in response to the receipt of the UL-PRS 706, and records an independent time t₂ at which the DL-PRS was sent. For example, the base station/TRP 704 sends a DL-PRS 716 as illustrated and records its time t₂ 712 at which the DL-PRS 716 was sent.

Each base station/TRP then proceeds to calculate a value t₂−t₁ using their independent values for t₂ and t₁.

The UE receives each DL-PRS at a time t₃ 714 (that may be different for each DL-PRS, considering that they arrive from different base stations/TRPs). The time that each DL-PRS is received is stored as a t₃ value. For example, as illustrated, the UE 702 receives the DL-PRS 716 from the base station/TRP 704, and stores the time of receipt as the time t₃ 714.

For each t₃ value corresponding to a received DL-PRS, the UE calculates a value t₃−t₀ for the corresponding base station/TRP and reports this information to the network. Further, based on information from each base station/TRP, the network is aware of/calculates a time t₂−t₁ for each base station/TRP.

Then, for each base station/TRP, a RTT of a signaling of the UL-PRS 706 and the corresponding DL-PRS for that base station/TRP between the UE 702 and that particular base station/TRP may be represented as RTT=(t₃−t₀)−(t₂−t₁), using the values that correspond to/derive from that base station/TRP. For example, the RTT corresponding to the UL-PRS 706 and the DL-PRS 716 is calculated using the values of t₀, t₁, t₂, and t₃ illustrated in the flow diagram 700.

Each RTT represents a sum of propagation delays corresponding to the UL-PRS and the DL-PRS for that base station/TRP. For example, the RTT value corresponding to the UE 702 and base station/TRP 704 represents the sum of the first propagation delay 718 and the first propagation delay 720 illustrated in the flow diagram 700.

A distance from a particular base station/TRP to the UE may then be estimated using distance=(RTT*c)/2, where c is the speed of light.

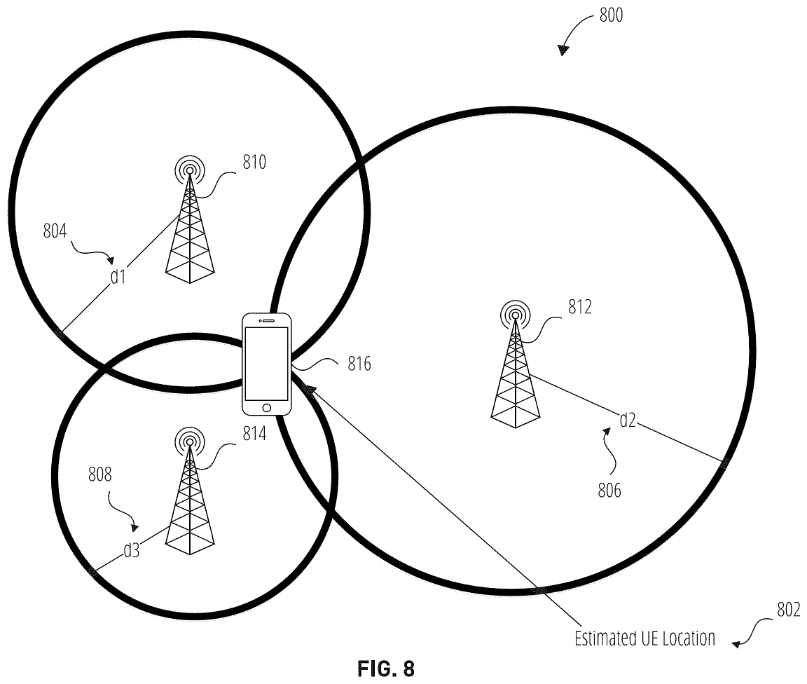

FIG. 8 illustrates a diagram 800 for using distances 804, 806, 808 from various base stations/TRPs 810, 812, and 814 to arrive at an estimated location 802 of a UE 816, according to an embodiment. A distance from each of the first base station/TRP 810, the second base station/TRP 812, and the third base station/TRP 814 to the UE 816 may be determined in the manner described above in relation to FIG. 7. In the example of FIG. 8, it has been determined that the UE 816 is a first distance 804 away from the first base station/TRP 810, a second distance 806 away from the second base station/TRP 812, and a third distance 808 away from the third base station/TRP 814.

Once this is accomplished, an estimated location 802 may be determined that is the point where circles extending outward from each base station/TRP with diameters of the applicable distance intersect. This aspect has been illustrated in the diagram 800.

UL-AoA and/or UL-TDOA mechanisms may be used in some NR networks for determining a location of a UE within the RAN.

A UL-AoA positioning method makes use of measured azimuth angle of arrival (A-AoA) and zenith angle of arrival (Z-AoA) data at multiple reception points (RPs) of UL signals (e.g., SRSs) transmitted from the UE. The RPs measure A-AoA and Z-AOA of the received signals using assistance data received from a positioning server, and the resulting measurements are used along with other configuration information to estimate the location of the UE.

A UL-TDOA positioning method makes use of uplink relative time of arrival (UL-RTOA) (and optionally uplink sounding reference signal reference signal received power (UL-SRS-RSRP)) data at multiple RPs of UL signals (e.g., SRSs) transmitted from the UE. The RPs measure the UL-TROA (and optionally the UL-SRS-RSRP) of the received signals using assistance data received from a positioning server, and the resulting measurements are used along with other configuration information to estimate the location of the UE.

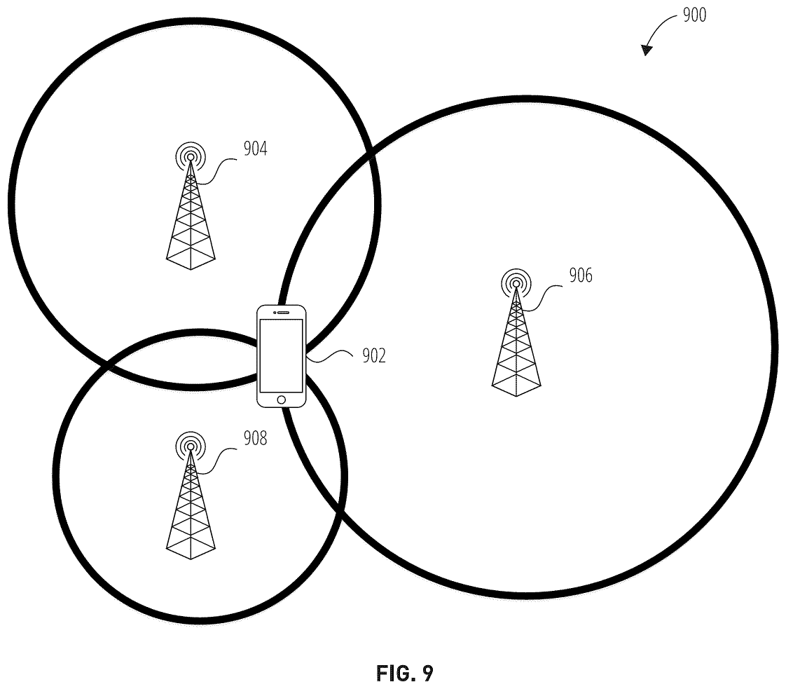

FIG. 9 illustrates a diagram 900 corresponding to the use of UL-AoA and/or UL-TDOA to locate a UE 902, according to embodiments disclosed herein.

For UL-AoA, the UE may transmit a UL signal that is received at each of the first base station/TRP 904, the second base station/TRP 906 and the third base station/TRP 908. Then, based on the A-AoA and the Z-AoA of the signal at each of the first base station/TRP 904, the second base station/TRP 906, and the third base station/TRP 908, the position of the UE may be determined.

For UL-TDOA, the UE may transmit an UL signal that is received at each of the first base station/TRP 904, the second base station/TRP 906 and the third base station/TRP 908. Then, based on an UL-RTOA of the UL signal (and optionally a UL-SRS-RSRP of the UL signal, in cases where the UL signal is an SRS) at each of the first base station/TRP 904, the second base station/TRP 906, and the third base station/TRP 908, the position of the UE may be determined.

Embodiments discussed herein may use positioning principles as understood from discussion herein particularly to NTN contexts. In some embodiments, the positioning principles are applied in such a way that a base station may independently select, trigger, control, and/or use a selected positioning mechanism without reliance/dependency on a CN (e.g., a location services (LCS) entity and/or LMF of a CN). Further, embodiments herein may accomplish this by using existing reference signals (RSs) (e.g., synchronization signal blocks (SSBs), channel state information reference signals (CSI-RSs), tracking reference signals (TRSs), etc.) and without the use of any newly-allocated positioning reference signal (PRS).

This base station triggered/controlled positioning mechanism may allow the network to identify the UE location. It is further contemplated that the use of the base station triggered/controlled positioning mechanism may be used by the network to verify a UE location within an NTN cell (e.g., verify the UE as being within a UE-reported location).

Attendant to the base station triggered/controlled positioning mechanism, the base station 1004 may be configured/pre-configured with the moving trajectory of NTN vehicles carrying corresponding payloads, and the geographic areas to which these correspond. In some cases, assistance data (e.g., from a CN) may be used in conjunction with the determination of these orbits, while in other cases a positioning server at the base station 1004 may instead be used as part of the determination of these orbits. The base station 1004 may further be equipped with the positioning calculation/estimation functionality that is described herein (and/or an LMF having this functionality may be sited at the base station).

Examples of positioning mechanisms useable an NTN context include a RTT mechanism, an uplink time difference of arrival (UL-TDOA) mechanism, and/or an uplink angle of arrival (UL-AoA) mechanism.

In such embodiments, a base station may provide the UE with a configuration to operate with the selected positioning mechanism (and the UE may then send responsive signaling to the base station accordingly). The base station may use this signaling (and its own information) to determine an estimated location of the UE. As discussed, the positioning mechanism may be itself triggered by the base station. In embodiments, these operations may all be accomplished independently from (e.g., without requiring), for example, any LPP capability and/or an NRPPa capability at the UE and/or the base station.

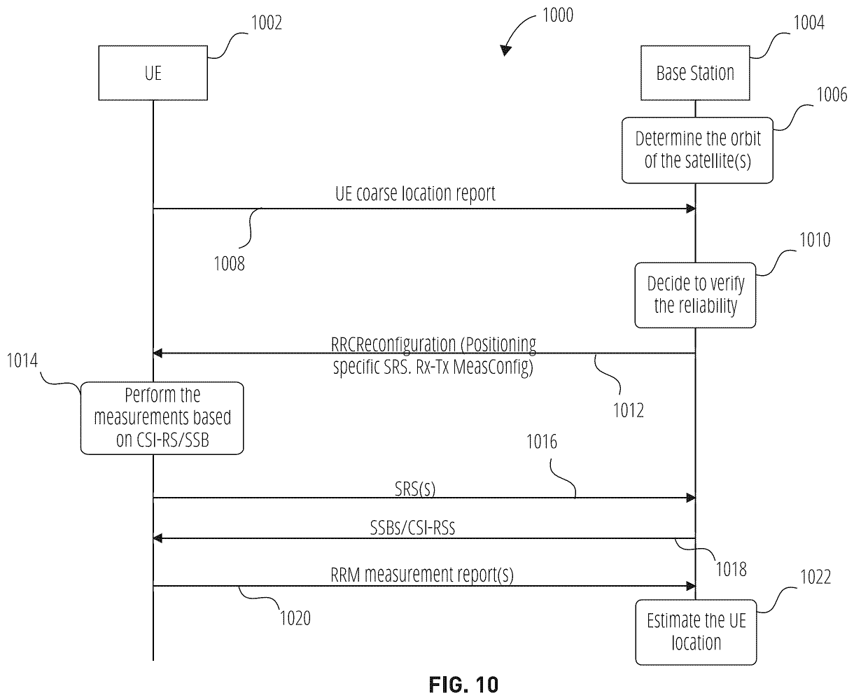

FIG. 10 illustrates a flow diagram 1000 of a base station triggered/controlled RTT positioning mechanism framework, according to an embodiment. The flow diagram 1000 illustrates signaling between and/or operations of a UE 702 and a base station/TRP 704 attendant to such a framework. The RTT positioning mechanism framework may be understood to be a multi-RTT framework, as described herein.

The example of FIG. 10 discusses the use of satellites, it will be understood that discussion of FIG. 10 analogously applies to cases involving other types of NTN vehicles.

The base station 1004 first determines 1006 the orbit of the satellite(s) carrying the payload(s) that are to be used as part of the selected positioning mechanism. This determination may be made using assistance data from the CN in some embodiments. The base station 1004 uses this information to determine the relevant position of each of the payload(s) at corresponding relevant time(s). As described herein, some RTT mechanisms use multiple payloads, while other RTT mechanism may use a single payload.

The UE 1002 then sends 1008 the base station 1004 a location report (e.g., a coarse location report, as illustrated) that reports the location of the UE (e.g., as nominally determined at the UE using GNSS) to the base station 1004.

The base station 1004 then decides 1010 to verify the reliability of the UE's location report.

Then, the base station 1004 sends 1012 a configuration message configuring the UE to report receive (Rx) minus transmit (Tx) (Rx−Tx) values (e.g., calculated values of t₃−t₀) to the base station 1004. For example, as illustrated, the configuration message may be a radio resource control (RRC) reconfiguration message having an Rx−Tx MeasConfig indication that indicates to the UE that it is to store and use the values of t₃ and t₀ and report corresponding Rx−Tx values.

Further, the configuration message may also indicate a type of SRS for the UE to use as part of the RTT positioning mechanism. As illustrated, a configuration message that is an RRC reconfiguration message can indicate that positioning specific SRS(s) (which will be referred to hereinafter more simply as SRS(s)) is/are to be used.

In response to the configuration message, the UE 1002 determines 1014 to perform the RTT measurements based on DL reference signals (e.g., CSI-RSs and/or SSBs) received from the payload(s). The type of DL reference signal (e.g., CSI-RSs, SSBs, etc.) to use may have been indicated in the configuration message. In FIG. 10, these DL reference signals are illustrated generally as SSB(s)/CSI-RS(s), but it should be understood in such cases that it may be that one or the other of these (or even some other type of DL reference signal) may be used.

The UE 1002 then sends 1016 SRS(s) as configured by the base station 1004. The UE 1002 records the time t₀ at which the SRS(s) is/are sent. The base station 1004 is made aware (e.g, via communication with the payload(s)) of the times t₁ that the SRS(s) is/are received at the payload(s).

The base station 1004 then sends 1018 (via the payload(s)) DL reference signals (e.g., SSBs, CSI-RSs) to the UE 1002 that are responsive to the receipt of the SRS/each SRS at each payload. The base station is made aware (e.g, via communication with the payload(s)) of the times t₂ at which these DL reference signals are sent by the payload(s). The UE 1002 records the times t₃ at which each DL reference signal is received at the UE 1002.

The UE 1002 then calculates a t₃−t₀ value corresponding to each SRS and DL reference signal pair for inclusion as part of one or more measurement report(s) (e.g., radio resource management (RRM) measurement report(s), as illustrated), with each such value representing an Rx−Tx value corresponding to the payload(s). The UE 1002 then sends 1020 these measurement report(s) to the base station 1004.

The base station 1004 may calculate t₂−t₁ values corresponding to each SRS and DL reference signal pair, with each such value representing an Rx−Tx value corresponding to the payload(s). In some of these cases, the base station 1004 may be aware of a timing drifting factor (denoted Δt) due to movement of the satellite during the time period corresponding to t₂−t₁ at the corresponding payload(s). Accordingly, an Rx−Tx value corresponding to the t₂-t₁ values may be further modified by Δt (e.g., an Rx−Tx value of t₂−t₁+Δt may be calculated) to improve accuracy.

Using the Rx−Tx values given in the measurement reports with their corresponding Rx−Tx values calculated at the base station 1004 for each SRS and DL reference signal pair, the base station 1004 calculates RTT times for signaling for each of the SRS and DL reference signal pairs. Using these RTT times, the base station 1004 determines distances of the UE from known positions of the payload(s). This allows the base station 1004 to estimate 1022 the UE location by identifying a point in space having a distance from each of those positions that is the appropriate corresponding value (e.g., in a manner analogous to that which has previously been discussed herein).

Then, the estimated location of the UE 1002 may then be compared to the location reported by the UE 1002. If these are not consistent, the base station 1004 may then proceed to restrict an operation of the UE 1002 with a network service for a geographical area corresponding to the UE's reported location based on the determination that the UE 1002 is not actually at the reported location and therefore may not be in the correct geographical area for the network service. For example, it may be that the UE 1002 is not permitted to perform some types of/any user plane communications on the network that would require that and/or that are otherwise based on an understanding that a UE is in that geographical area unless and until the UE 1002 later reports a verifiable location in the geographical area. This restriction may include rejecting an attempted connection by the UE 1002 with a CN/AMF corresponding to operation in the geographical area.

It is noted that the methods discussed in relation to FIG. 10 may be used outside of the UE location verification context. In other words, it is contemplated that these methods may be used to determine a location of the UE for reasons other than the verification of a UE-reported location (and in such cases, the sending and/or receipt of a UE location report may not be performed and/or may not be relevant).

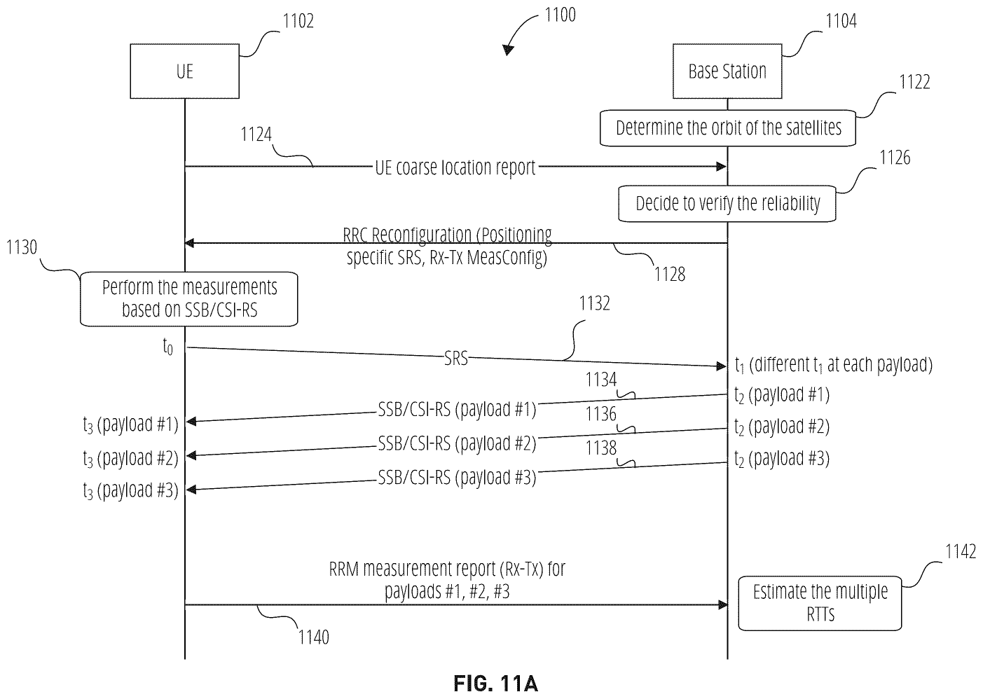

FIG. 11A illustrates a flow diagram 1100 showing an example use of a base station triggered/controlled RTT positioning mechanism, according to an embodiment. FIG. 11B illustrates a diagram 1120 corresponding to an example use of a base station triggered/controlled RTT positioning mechanism. The diagram 1120 of FIG. 11B corresponds to the flow diagram 1100 of FIG. 11A, and thus the flow diagram 1100 and the diagram 1120 will be discussed together. The RTT positioning mechanism illustrated in FIG. 11A and FIG. 11B may be understood to be a multi-RTT framework, as described herein.

The example illustrated by FIG. 11A and FIG. 11B applies the generalized example given by the flow diagram 1000 of FIG. 10 to use RTTs between multiple payloads of multiple satellites and a UE in a serving cell of the base station during a single measurement instance.

The flow diagram 1100 illustrates the signaling between and operations of a UE 1102 and a base station 1104. As illustrated with reference to the diagram 1120, the base station 1104 operates with the UE via a number of payloads on a number of satellites (e.g., the payload #1 1108 on satellite #1 1106, the payload #2 1112 on satellite #2 1110, and the payload #3 1116 on satellite #3 1114). The payload #1 1108, the payload #2 1112 and the payload #3 1116 operate (in concert) the serving cell 1118 of the base station 1104 which is presently used by the UE 1102 to communicate with the base station 1104.

Note that while the example of FIG. 11A and FIG. 11B discusses the use of satellites, it will be understood that the discussion analogously applies to cases involving other types of NTN vehicles.

The base station 1104 first determines 1122 the orbit of each of the payload #1 1108, the payload #2 1112, and the payload #3 1116. In some cases, assistance data (e.g., from a CN) may be used in conjunction with the determination of these orbits, while in other cases a positioning server at the base station 1104 may instead be used as part of the determination of these orbits. The base station 1104 uses this information to determine the relevant position of each of the payload #1 1108, the payload #2 1112, and the payload #3 1116 at the measurement instance illustrated in FIG. 11B.

The UE 1102 then sends 1124 the base station 1104 a location report (e.g., a coarse location report, as illustrated) that reports the location of the UE.

The base station 1104 then decides 1126 to verify the reliability of the UE's location report.

Then, the base station 1104 sends 1128 an RRC reconfiguration message configuring the UE to report Rx−Tx values (e.g., calculated values of t₃−t₀ corresponding to each of the payload #1 1108, payload #2 1112, and payload #3 1116) to the base station 1104. This RRC reconfiguration message also indicates a positioning specific SRS (which will be referred to hereinafter more simply as an SRS) that the UE is to transmit.

In response to the receipt of the RRC reconfiguration message, the UE 1102 determines 1130 to perform the RTT measurements based on DL reference signals (e.g., CSI-RSs and/or SSBs) received from each of the payload #1 1108, the payload #2 1112, and the payload #3 1116. In FIG. 11A, these DL reference signals are illustrated generally as SSB/CSI-RS reference signals, but it should be understood in such cases that it may be that one or the other of these (or even some other type of DL reference signal) may be used.

The UE 1102 then sends 1132 the SRS as was configured by the base station 1004 in the RRC reconfiguration message. The UE 1102 records the time t₀ at which the SRS is sent.

This SRS is received at each of the payload #1 1108, the payload #2 1112, and the payload #3 1116. The base station 1004 is made aware (e.g., via communication with each of the payload #1 1108, the payload #2 1112, and the payload #3 1116) of times t₁ that the SRS is received at each payload. As illustrated, the SRS may be received at each payload at a different time t₁ for that payload.

The base station 1104 then sends 1134 a first DL reference signal (e.g., an SSB/CSI-RS, as illustrated) to the UE 1102. This first DL reference signal is sent by the payload #1 1108 and in response to the receipt of the SRS at the payload #1 1108. Further, the base station 1104 sends 1136 a second DL reference signal (e.g., an SSB/CSI-RS, as illustrated) to the UE 1102. This second DL reference signal is sent by the payload #2 1112 and in response to the receipt of the SRS at the payload #2 1112. Further, the base station 1104 sends 1138 a third DL reference signal (e.g., an SSB/CSI-RS, as illustrated) to the UE 1102. This third DL reference signal is sent by the payload #3 1116 and in response to the receipt of the SRS as the payload #3 1116.

The base station 1104 is made aware (e.g., via communication with each of the payload #1 1108, the payload #2 1112, and the payload #3 1116) of the times t₂ at which these respective DL reference signals are sent by each payload. The UE 1102 records the times t₃ at which each respective DL reference signal is received at the UE 1102.

It is noted that while the sending operations 1134, 1136, and 1138 have been illustrated in order of payload and with discernable timing gaps, this is by way of example only. There is no inherent limitation in either a relative ordering or a relative timing of these operations as among the payloads.

The UE 1102 then calculates a t₃−t₀ values corresponding a paring of the SRS with each received DL reference signal for inclusion as part of a measurement report (e.g., an RRM measurement report, as illustrated), with each such value representing an Rx−Tx value corresponding to one of the payload #1 1108, the payload #2 1112, and the payload #3 1116. The UE 1102 then sends 1140 a measurement report having these Rx−Tx values to the base station 1104.

The measurement report may indicate an RS index and/or a system frame number (SFN)/slot/subframe where an RS was received corresponding to each DL reference signal for which an Rx−Tx value is being reported. This information may be used by the base station 1104 to identify the particular DL reference signal corresponding to each Rx−Tx value in the measurement report.

The base station 1104 calculates t₂−t₁ values corresponding to each SRS/DL reference signal pair, with each such value representing an Rx−Tx value corresponding to one of the payload #1 1108, the payload #2 1112, and the payload #3 1116. In some of these cases, the base station 1104 may be aware of a timing drifting factor (denoted Δt) due to movement of any/each of the payload #1 1108, the payload #2 1112, and the satellite #3 1114 during the time period corresponding to t₂−t₁ at the corresponding one of the payload #1 1108, the payload #2 1112, and the payload #3 1116. Accordingly, an Rx−Tx value corresponding to these t₂−t₁ values may be further modified by a corresponding Δt (e.g., an Rx−Tx value of t₂−t₁+Δt may be calculated) to improve accuracy.

Using the Rx−Tx values given in the measurement reports with their corresponding Rx−Tx values calculated at the base station 1104 for each SRS/DL reference signal pair, the base station 1104 estimates 1142 RTT times for signaling for each of the SRS/DL reference signal pairs. Using these RTT times, the base station 1104 determines distances of the UE 1102 from known positions of each of the payload #1 1108, the payload #2 1112, and the payload #3 1116. This allows the base station 1104 to estimate the location of the UE 1102 by identifying a point in space having a distance from each of those positions that is the appropriate corresponding value (e.g., in a manner analogous to that which has previously been discussed herein).

Then, the estimated location of the UE 1102 may then be compared to the location reported by the UE 1102. If these are not consistent, the base station 1104 may then proceed to restrict an operation of the UE 1102 with a network service for a geographical area corresponding to the UE's reported location based on the determination that the UE 1102 is not actually at the reported location and therefore may not be in the correct geographical area for the network service. For example, it may be that the UE 1102 is not permitted to perform some types of/any user plane communications on the network that would require that and/or that are otherwise based on an understanding that a UE is in that geographical area unless and until the UE 1102 later reports a verifiable location in the geographical area. This restriction may include rejecting an attempted connection by the UE 1102 with a CN/AMF corresponding to operation in the geographical area.

It is noted that the methods discussed in relation to FIG. 11A and FIG. 11B may be used outside of the UE location verification context. In other words, it is contemplated that these methods may be used to determine a location of the UE for reasons other than the verification of a UE-reported location (and in such cases, the sending and/or receipt of a UE location report may not be performed and/or may not be relevant).

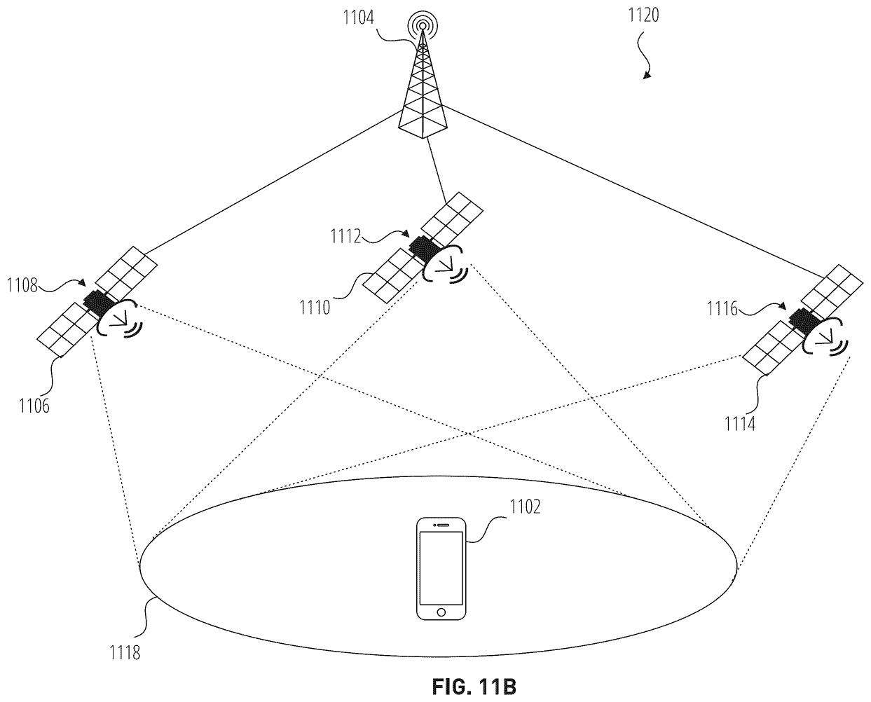

FIG. 12 illustrates a method 1200 of a base station, according to an embodiment. The method 1200 includes determining 1202 positions of a plurality of NTN payloads operating a serving cell of the base station.

The method 1200 further includes sending 1204, to a UE, a configuration message configuring the UE to report first Rx−Tx values corresponding to the plurality of NTN payloads, the first Rx−Tx values to indicate lengths of first time periods between a time of transmission of an UL reference signal from the UE and times of receipt of DL reference signals at the UE.

The method 1200 further includes determining 1206 second Rx−Tx values corresponding to the plurality of NTN payloads, wherein the second Rx−Tx values indicate lengths of second time periods between times of receipt the UL reference signal from the UE at the plurality of NTN payloads and times of transmission of the DL reference signals from respective ones of the plurality of NTN payloads.

The method 1200 further includes receiving 1208, from the UE, a measurement report comprising the first Rx−Tx values corresponding to the plurality of NTN payloads.

The method 1200 further includes calculating 1210 distances of the UE from the positions of the plurality of NTN payloads using the first Rx−Tx values and the second Rx−Tx values.

The method 1200 further includes determining 1212 a location of the UE within the serving cell based on the positions of the plurality of NTN payloads and the distances of the UE from the positions of the plurality of NTN payloads.

In some embodiments of the method 1200, the second Rx−Tx values are further determined using drifting factors based on movements of the plurality of NTN payloads from the positions during the second time periods.

In some embodiments, the method 1200 further includes receiving, from the UE, a reported location of the UE within the serving cell, determining that the reported location of the UE is not consistent with the location of the UE, and restricting an operation of the UE with a network service for a geographical area corresponding to the reported location of the UE based on the determination that the reported location of the UE is not consistent with the location of the UE.

In some embodiments of the method 1200, the configuration message further configures the UE to use a positioning specific SRS, and wherein the UL reference signal comprises the positioning specific SRS.

In some embodiments of the method 1200, the DL reference signals comprise SSBs.

In some embodiments of the method 1200, the DL reference signals comprise CSI-RSs.

In some embodiments of the method 1200, the configuration message comprises an RRC configuration message.

In some embodiments of the method 1200, the measurement report further includes reference signal indexes that correspond the DL reference signals to the first Rx−Tx values.

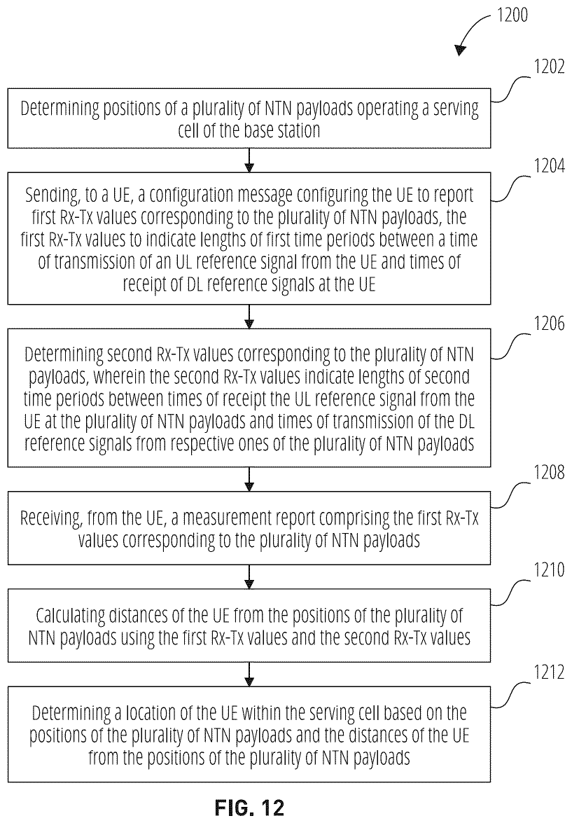

FIG. 13A illustrates a flow diagram 1300 showing an example use of a base station triggered/controlled RTT positioning mechanism, according to an embodiment. FIG. 13B illustrates a diagram 1344 corresponding to an example use of a base station triggered/controlled RTT positioning mechanism. The diagram 1344 of FIG. 13B corresponds to the flow diagram 1300 of FIG. 13A, and thus the flow diagram 1300 and the diagram 1344 will be discussed together. The RTT positioning mechanism illustrated in FIG. 13A and FIG. 13B may be understood to be a multi-RTT framework, as described herein.

The example illustrated by FIG. 13A and FIG. 13B applies the generalized example given by the flow diagram 1000 of FIG. 10 to use RTTs with a single payload of a single satellite and a UE in a serving cell of the base station during multiple measurement instances.

The flow diagram 1300 illustrates the signaling between and operations of a UE 1302 and a base station 1304. As illustrated with reference to the diagram 1344, the base station 1304 operates with the UE via the payload 1350 on satellite 1348. Specifically, the payload 1350 operates the serving cell 1354 of the base station 1304 which is presently used by the UE 1302 to communicate with the base station 1304. In the diagram 1344 of FIG. 13B, the satellite 1348 is illustrated as moving through its orbit 1352, with the locations of the satellite 1348 (and thus the payload 1350 sited on the satellite 1348) expressly illustrated during each of a set of measurement instances including the measurement instance T1 1316, the measurement instance T2 1318, and the measurement instance T3 1320.

Note that while the example of FIG. 13A and FIG. 13B discusses the use of satellites, it will be understood that discussion of FIG. 13A and FIG. 13B analogously applies to cases involving other types of NTN vehicles.

The base station 1304 first determines 1306 the orbit 1352 of the payload 1350. In some cases, assistance data (e.g., from a CN) may be used in conjunction with the determination of these orbits, while in other cases a positioning server at the base station 1304 may instead be used as part of the determination of these orbits. The base station 1304 uses this information to determine the relevant position of each of the payload 1350 at each of the measurement instance T1 1316, the measurement instance T2 1318, and the measurement instance T3 1320.

The UE 1302 then sends 1308 the base station 1304 a location report (e.g., a coarse location report, as illustrated) that reports the location of the UE.

The base station 1304 then decides 1310 to verify the reliability of the UE's location report.

Then, the base station 1304 sends 1312 an RRC reconfiguration message configuring the UE to report Rx−Tx values (e.g., calculated values of t₃−t₀ corresponding to the payload 1350) to the base station 1304. In the example illustrated in the flow diagram 1300, the illustrated RRC message identifies the measurement instance T1 1316, the measurement instance T2 1318, and the measurement instance T3 1320 to the UE so that the UE is informed of when signaling for generating these values of t₃−t₀ is to occur. This RRC reconfiguration message also indicates a positioning specific SRS (which will be referred to hereinafter more simply as an SRS) that the UE is to transmit during each of the measurement instance T1 1316, the measurement instance T2 1318, and the measurement instance T3 1320.

In response to the receipt of the RRC reconfiguration message, the UE 1302 determines 1314 to perform the RTT measurements based on DL reference signals (e.g., CSI-RSs and/or SSBs) received from the payload 1350 during each of the measurement instance T1 1316, the measurement instance T2 1318, and the measurement instance T3 1320. In FIG. 13A, these DL reference signals are illustrated generally as SSB/CSI-RS reference signals, but it should be understood in such cases that it may be that one or the other of these (or even some other type of DL reference signal) may be used.

During the measurement instance T1 1316, the UE 1302 sends 1322 a first SRS as was configured by the base station 1304 in the RRC reconfiguration message. The UE 1302 records the time to at which the first SRS is sent.

This SRS is received at the payload 1350, and the base station 1304 is made aware of (e.g., via communication with the payload 1350) the time t₁ that the SRS is received at the payload.

The base station 1304 then sends 1324 a first DL reference signal (e.g., an SSB/CSI-RS, as illustrated) to the UE 1302. This first DL reference signal is sent by the payload 1350 and in response to the receipt of the first SRS at the payload 1350. The base station 1304 is made aware of (e.g., via communication with the payload 1350) the time t₂ at which the first DL reference signal is sent.

The UE 1302 receives the first DL reference signal and records the time t₃ at which it was received.

The UE 1302 then calculates a first t₃−t₀ value corresponding to the first SRS and the first DL reference signal for inclusion as part of a first measurement report (e.g., the first RRM measurement report, as illustrated), with the first t₃−t₀ value representing a Rx−Tx value corresponding to the payload 1350 and its location during the measurement instance T1 1316 (e.g, as illustrated in the diagram 1344). The UE 1302 then sends 1326 a first measurement report having these Rx−Tx values to the base station 1304.

The base station 1304 calculates a first t₂−t₁ value corresponding to the first SRS and the first DL reference signal, with the first t₂−t₁ value representing a Rx−Tx value corresponding to the payload 1350 and its location during the measurement instance T1 1316 (e.g, as illustrated in the diagram 1344). In some cases, the base station 1304 may be aware of a timing drifting factor (denoted Δt) due to movement of the satellite 1348 during the time period corresponding to t₂−t₁ at the corresponding payload 1350. Accordingly, the Rx−Tx value corresponding to the first t₂−t₁ value may be further modified by Δt (e.g., an Rx−Tx value of t₂−t₁+Δt may be calculated) to improve accuracy.

Using the Rx−Tx value given in the measurement report with its corresponding Rx−Tx value calculated at the base station 1304, the base station 1304 estimates 1340 a RTT time for the signaling of the first SRS and the first DL reference signal.

It can be seen in reference to the flow diagram 1300 that additional RTT values may be estimated using additional Rx−Tx values in the form of additional t₃−t₀ values and t₂−t₁ values corresponding to the measurement instance T2 1318 and the measurement instance T3 1320.

For example, for the measurement instance T2 1318, the UE 1302 sends 1328 a second SRS to the base station 1304 and the base station 1304 sends 1330 a second DL reference signal in reply. Rx−Tx values corresponding to the second illustrated values of t₀, t₁, t₂, and t₃ are calculated at the UE 1302 (which calculates a second t₃−t₀ value) and the base station 1304 (which calculates a second t₂−t₁ value), and the UE 1302 sends 1332 a second measurement report having a Rx−Tx value in the form of the second t₃−t₀ value to the base station 1304. Using the Rx−Tx value given in the second measurement report with its corresponding Rx−Tx value calculated at the base station 1304, the base station 1304 estimates 1342 a second RTT for the signaling of the second SRS and the second DL reference signal.

Further, for the measurement instance T3 1320, the UE 1302 sends 1334 a third SRS to the base station 1304 and the base station 1304 sends 1336 a third DL reference signal in reply. Rx−Tx values corresponding to the third illustrated values of t₀, t₁, t₂, and t₃ are calculated at the UE 1302 (which calculates a third t₃−t₀ value) and the base station 1304 (which calculates a third t₂−t₁ value), and the UE 1302 sends 1338 a third measurement report having its corresponding Rx−Tx value in the form of the third t₃−t₀ value to the base station 1304. Using the Rx−Tx value given in the third measurement report with its corresponding Rx−Tx value calculated at the base station 1304, the base station 1304 estimates 1346 a third RTT for the signaling of the third SRS and the third DL reference signal.

It is noted that the first, second and third RTTs are distinct due to the fact that the satellite 1348 (and thus the payload 1350) are in distinct locations at each of the measurement instance T1 1316, the measurement instance T2 1318, and the measurement instance T3 1320 due to the movement of the satellite 1348 along the orbit 1352. These locations are known to the base station 1304, as previously discussed.

Using these RTT times, the base station 1304 determines distances of the UE from the known positions of each of the payload 1350 at the corresponding the measurement instances for those RTT times. This allows the base station 1304 to estimate the UE location by identifying a point in space having a distance from each of those positions that is the appropriate corresponding value (e.g., in a manner analogous to that which has previously been discussed herein).

Then, the estimated location of the UE 1302 may then be compared to the location reported by the UE 1302. If these are not consistent, the base station 1304 may then proceed to restrict an operation of the UE 1302 with a network service for a geographical area corresponding to the UE's reported location based on the determination that the UE 1302 is not actually at the reported location and therefore may not be in the correct geographical area for the network service. For example, it may be that the UE 1302 is not permitted to perform some types of/any user plane communications on the network that would require that and/or that are otherwise based on an understanding that a UE is in that geographical area unless and until the UE 1302 later reports a verifiable location in the geographical area. This restriction may include rejecting an attempted connection by the UE 1302 with a CN/AMF corresponding to operation in the geographical area.

It is noted that the methods discussed in relation to FIG. 13A and FIG. 13B may be used outside of the UE location verification context. In other words, it is contemplated that these methods may be used to determine a location of the UE for reasons other than the verification of a UE-reported location (and in such cases, the sending and/or receipt of a UE location report may not be performed and/or may not be relevant).

It is further noted that in alternative embodiments from that illustrated in flow diagram 1300, individual configuration messages (e.g., individual RRC reconfiguration messages), each configuring a report by the UE of a single Rx−Tx value for an individual measurement instance, may be used to inform a UE of when signaling for the values of t₃−t₀ is to occur. In such instances, these RRC messages may occur based on a trigger by a base station, for example, a one-shot trigger and/or an event based trigger. In the case of a one-shot trigger, the UE may measure and report a Rx−Tx value in response to a corresponding base station indication. In the case of an event-based trigger, the base station may configure the UE to measure and report a Rx−Tx value at a certain time in the future.

In other alternative embodiments from that illustrated in flow diagram 1300, a configuration message (e.g., an RRC reconfiguration message) may configure multiple measurement instances to a UE using a periodicity value that the UE uses to determine the relevant measurement instances (e.g., rather than the configuration message providing an express indication of each measurement instance).

It is further noted that while the flow diagram 1300 illustrates the use of a first measurement report, a second measurement report, and a third measurement report, each having a corresponding Rx−Tx value calculated by the UE 1302, it is contemplated that other embodiments may aggregate multiple Rx−Tx values calculated by a UE over time into a single measurement report that is then sent to the base station.

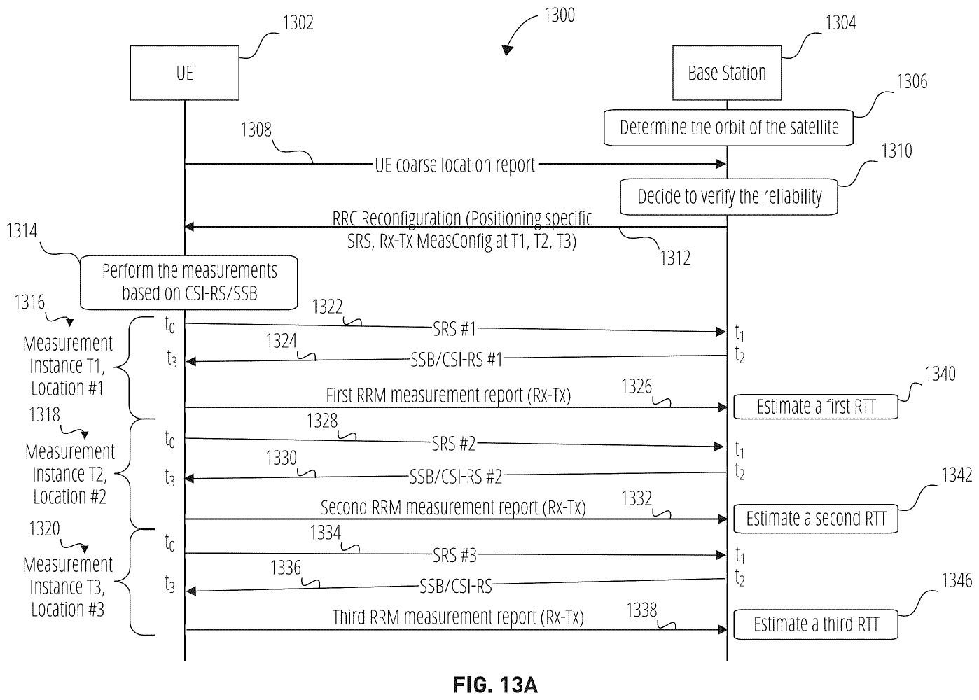

FIG. 14 illustrates a method 1400 of a base station, according to an embodiment. The method 1400 includes determining 1402, corresponding to a plurality of measurement instances, positions of a NTN payload that is moving relative to a terrestrial location of the base station, wherein the NTN vehicle is operating a serving cell of the base station.

The method 1400 further includes sending 1404, to a UE, one or more configuration messages configuring the UE to report first Rx−Tx values corresponding to the plurality of measurement instances, the first Rx−Tx values to indicate lengths of first time periods between times of transmission of UL reference signals from the UE during corresponding ones of the plurality of measurement instances and times of receipt of corresponding DL reference signals at the UE.

The method 1400 further includes determining 1406 second Rx−Tx values during the measurement instances, wherein the second Rx−Tx values indicate lengths of second time periods between times of receipt of the UL reference signals from the UE at the NTN payload and times of transmission of the corresponding DL reference signals from the NTN payload.

The method 1400 further includes receiving 1408, from the UE, the first Rx−Tx values.

The method 1400 further includes calculating 1410 distances of the UE from the positions of the NTN payload during the measurement instances using the first Rx−Tx values and the second Rx−Tx values.

The method 1400 further includes determining 1412 a location of the UE within the serving cell based on the positions of the NTN payload during the measurement instances and the distances of the UE from the positions of the NTN payload during the measurement instances.

In some embodiments of the method 1400, the second Rx−Tx values are further determined using drifting factors based on movements of the NTN payloads from the positions during the second time periods.

In some embodiments, the method 1400 further includes receiving, from the UE, a reported location of the UE within the serving cell, determining that the reported location of the UE is not consistent with the location of the UE, and restricting an operation of the UE with a network service for a geographical area corresponding to the reported location of the UE based on the determination that the reported location of the UE is not consistent with the location of the UE.

In some embodiments of the method 1400, the one or more configuration messages further configure the UE to use positioning SRSs, and wherein the UL reference signals comprise the positioning specific SRSs.

In some embodiments of the method 1400, the DL reference signals comprise SSBs.

In some embodiments of the method 1400, the DL reference signals comprise CSI-RSs.

In some embodiments of the method 1400, the one or more configuration messages comprise a RRC configuration message.

In some embodiments of the method 1400, the one of the one or more configuration messages expressly indicates the plurality of measurement instances.

In some embodiments of the method 1400, one of the one or more configuration messages indicates a periodicity for the UE to use to determine the plurality of measurement instances.

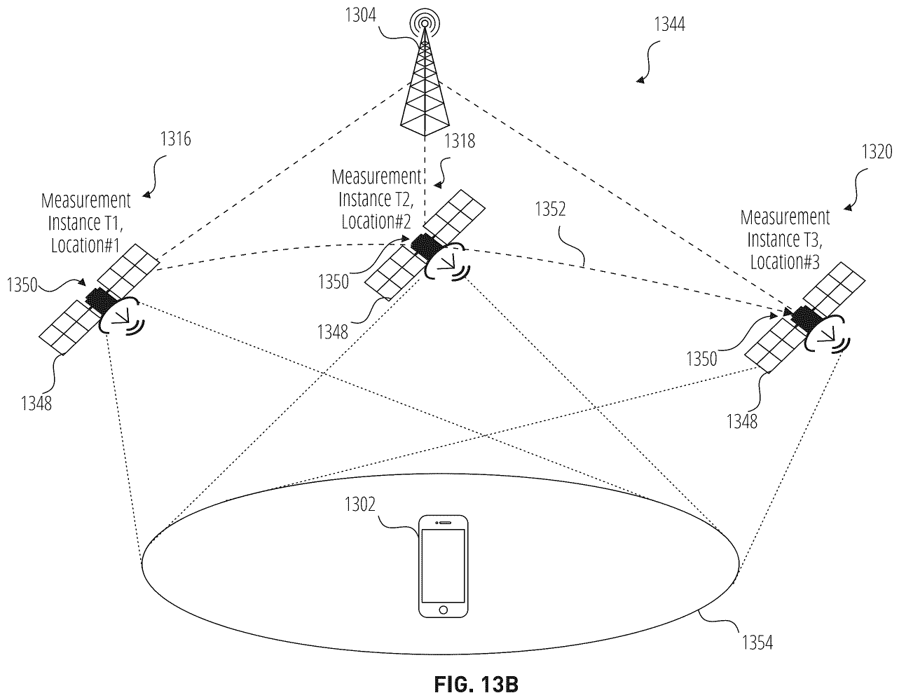

FIG. 15 illustrates a diagram 1500 corresponding to an example use of a base station triggered/controlled UL-AoA and/or UL-TDOA positioning mechanism. The example illustrated by FIG. 15 uses UL-AoA and/or UL-TDOA with multiple payloads of multiple satellites and a UE in a serving cell of the base station during a single measurement instance.

As illustrated with reference to the diagram 1500, the base station 1504 operates with the UE 1502 via a number of payloads on a number of satellites (e.g., the payload #1 1508 on satellite #1 1506, the payload #2 1512 on satellite #2 1510, and the payload #3 1516 on satellite #3 1514). The payload #1 1508, the payload #2 1512 and the payload #3 1516 operate (in concert) the serving cell 1518 of the base station 1504 which is presently used by the UE 1502 to communicate with the base station 1504.

Note that while the example of FIG. 15 discusses the use of satellites, it will be understood that discussion of FIG. 15 analogously applies to cases involving other types of NTN vehicles.

The base station 1504 first determines the orbit of each of the payload #1 1508, the payload #2 1512, and the payload #3 1516. In some cases, assistance data (e.g., from a CN) may be used in conjunction with the determination of these orbits, while in other cases a positioning server at the base station 1504 may instead be used as part of the determination of these orbits. The base station 1504 uses this information to determine the relevant position of each of the payload #1 1508, the payload #2 1512, and the payload #3 1516 at the measurement instance illustrated in FIG. 15.

For UL-AoA, the UE may be configured by the base station 1802 to transmit a UL signal (e.g., an SRS). This UL signal is received at each of the payload #1 1508, the payload #2 1512, and the payload #3 1516. Then, based on the A-AoA and the Z-AoA of the signal at each of the payload #1 1508, the payload #2 1512, and the payload #3 1516 (as delivered to the base station 1504 from each of the payload #1 1508, the payload #2 1512, and the payload #3 1516) and the corresponding known location of each of the payload #1 1508, the payload #2 1512, and the payload #3 1516, the position of the UE may be determined at the base station 1504.

For UL-TDOA, the UE may be configured by the base station 1802 to transmit an UL signal (e.g., an SRS. These UL signals are received at each of the payload #1 1508, the payload #2 1512, and the payload #3 1516. Then, based on the UL-RTOA of the UL signal (and optionally the UL-SRS-RSRPs of the UL signal, in cases where the UL signals are an SRSs) at each of the payload #1 1508, the payload #2 1512, and the payload #3 1516 (as delivered to the base station 1504 from each of the payload #1 1508, the payload #2 1512, and the payload #3 1516) and the corresponding known location of each of the payload #1 1508, the payload #2 1512, and the payload #3 1516, the position of the UE may be determined at the base station 1504.

In some embodiments, this determined position may be used to, for example, perform verification of a UE-reported position, in the manner and with the potential results that have been discussed herein.

It is noted that the UL-AoA and/or UL-TDOA mechanism(s) as discussed relative to FIG. 15 are not dependent on, for example, an LPP capability and/or an NRPPa capability of the UE 1502 and/or the base station 1504.

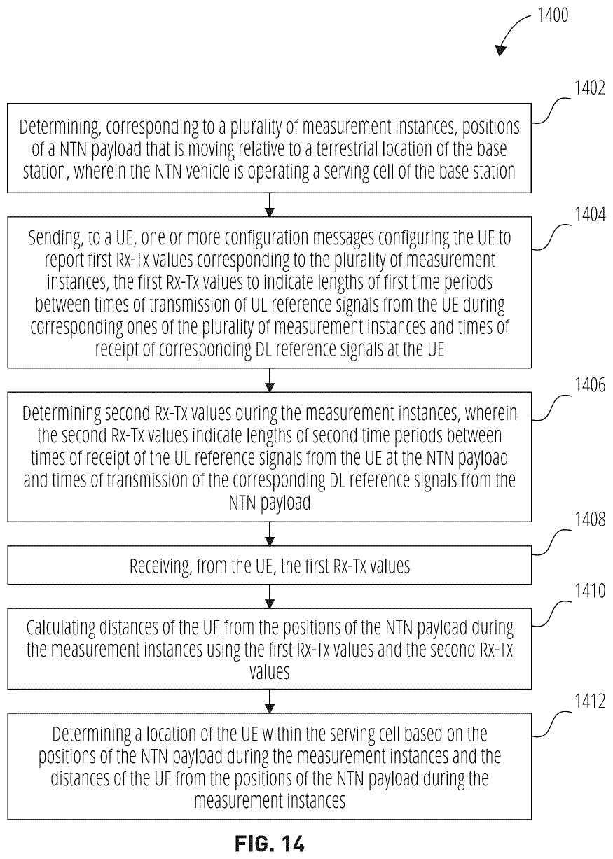

FIG. 16 illustrates a method 1600 of a base station, according to an embodiment. The method 1600 includes determining 1602 positions of a plurality of NTN payloads operating a serving cell of the base station.

The method 1600 further includes sending 1604, to a UE, a configuration message configuring the UE to transmit an UL reference signal.

The method 1600 further includes receiving 1606 A-AoA data and Z-AoA data corresponding to the UL reference signal from the plurality of NTN payloads.

The method 1600 further includes determining 1608, at the base station, a location of the UE in the serving cell based on the A-AoA data and the Z-AoA data.

In some embodiments of the method 1600, the UL reference signal comprises an SRS.

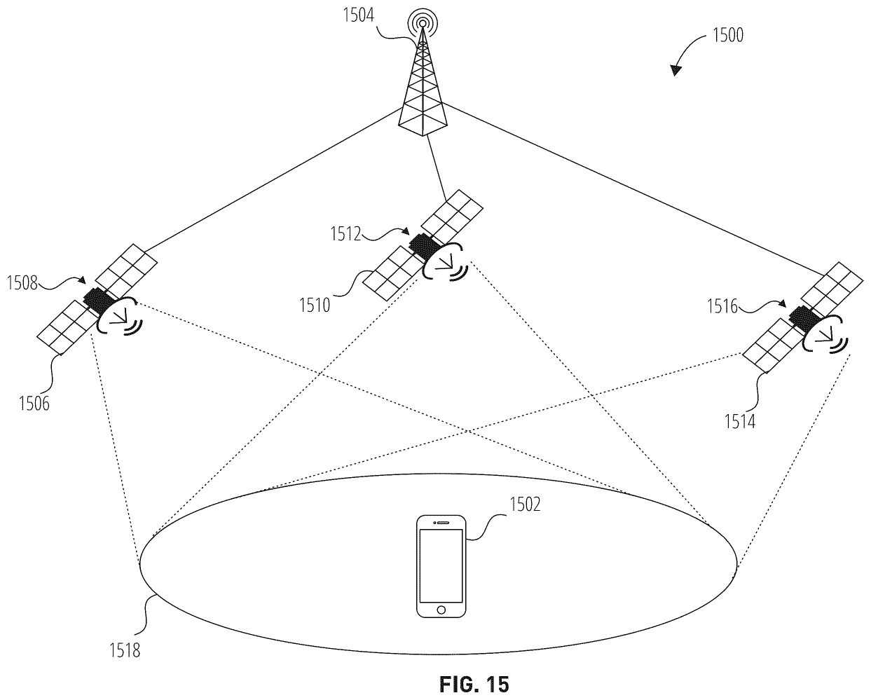

FIG. 17 illustrates a method 1700 of a base station, according to an embodiment. The method 1700 includes determining 1702 positions of a plurality of NTN payloads operating a serving cell of the base station.

The method 1700 further includes sending 1704, to a UE, a configuration message configuring the UE to transmit an UL reference signal.

The method 1700 further includes receiving 1706 UL-RTOA data corresponding to the UL reference signal from the plurality of NTN payloads.

The method 1700 further includes determining 1708, at the base station, a location of the UE in the serving cell based on the UL-RTOA data.

In some embodiments of the method 1700, the UL reference signal comprises an SRS.

In some embodiments, the method 1700 further includes receiving UL-SRS-RSRP data corresponding to the UL reference signal from the plurality of NTN payloads, and the location of the UE in the serving cell is further determined based on the UL-SRS-RSRP data.

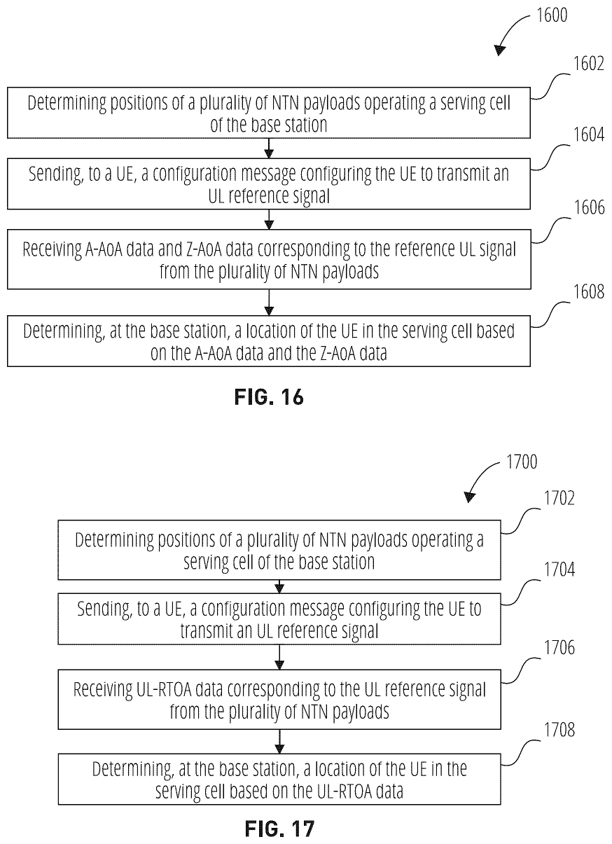

FIG. 18 illustrates a diagram 1800 corresponding to an example use of a base station triggered/controlled UL-AoA and/or UL-TDOA positioning mechanism. The example illustrated by FIG. 18 uses UL-AoA and/or UL-TDOA with a single payload of a single satellite and a UE in a serving cell of the base station during multiple measurement instances.

As illustrated with reference to the diagram 1800, the base station 1802 operates with the UE via the payload 1816 on satellite 1804. Specifically, the payload 1816 operates the serving cell 1808 of the base station 1802 which is presently used by the UE 1806 to communicate with the base station 1802. In the diagram 1800 of FIG. 18 the satellite 1804 is illustrated as moving through its orbit 1818, with the locations of the satellite 1804 (and thus the payload 1816 sited on the satellite 1804) expressly illustrated during each of a set of measurement instances including the measurement instance T1 1810, the measurement instance T2 1812, and the measurement instance T3 1814.

Note that while the example of FIG. 18 discusses the use of satellites, it will be understood that discussion of FIG. 18 analogously applies to cases involving other types of NTN vehicles.

The base station 1802 first determines the orbit of each the payload 1816. In some cases, assistance data (e.g., from a CN) may be used in conjunction with the determination of the orbit, while in other cases a positioning server at the base station 1802 may instead be used as part of the determination of the orbit. The base station 1802 uses this information to determine the relevant position of the payload 1816 at each of the measurement instance T1 1810 the measurement instance T2 1812, and the measurement instance T3 1814.

For UL-AoA, the UE may be configured by the base station 1802 to transmit a UL signal (e.g., an SRS) at each of the measurement instance T1 1810 the measurement instance T2 1812, and the measurement instance T3 1814. These UL signals are received at the payload 1816 during each respective one of the measurement instance T1 1810, the measurement instance T2 1812, and the measurement instance T3 1814. Then, based on the A-AoA and the Z-AoA of the signal at each of the measurement instance T1 1810, the measurement instance T2 1812, and the measurement instance T3 1814 (as delivered to the base station 1802 from the payload 1816) and the corresponding known location of the payload 1816 during the measurement instance T1 1810, the measurement instance T2 1812 and the measurement instance T3 1814, the position of the UE may be determined at the base station 1802.

For UL-TDOA, the UE may be configured by the base station 1802 to transmit an UL signal (e.g., an SRS) at each of the measurement instance T1 1810 the measurement instance T2 1812, and the measurement instance T3 1814. These UL signals are received at the payload 1816 during each respective one of the measurement instance T1 1810, the measurement instance T2 1812, and the measurement instance T3 1814. Then, based on the UL-RTOA of the UL signals (and optionally the UL-SRS-RSRPs of the UL signals, in cases where the UL signals are an SRSs) at each of the measurement instance T1 1810, the measurement instance T2 1812, and the measurement instance T3 1814 (as delivered to the base station 1802 from the payload 1816) and the corresponding known location of the payload 1816 during the measurement instance T1 1810, the measurement instance T2 1812 and the measurement instance T3 1814, the position of the UE may be determined at the base station 1802.

In some embodiments, this determined position may be used to, for example, perform verification of a UE-reported position, in the manner and with the potential results that have been discussed herein.

It is noted that the UL-AoA and/or UL-TDOA mechanism(s) as discussed relative to FIG. 18 are not dependent on, for example, an LPP capability and/or an NRPPa capability of the UE 1806 and/or the base station 1802.

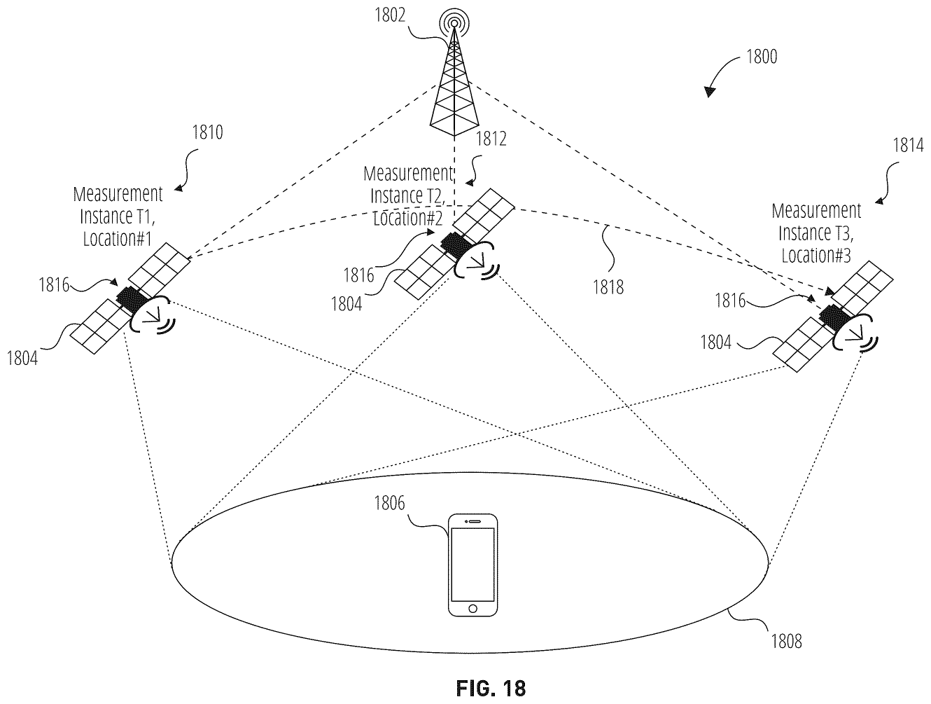

FIG. 19 illustrates a method 1900 of a base station, according to an embodiment. The method 1900 includes determining 1902, corresponding to a plurality of measurement instances, positions of an NTN payload that is moving relative to a terrestrial location of the base station, wherein the NTN payload is operating a serving cell of the base station.

The method 1900 further includes sending 1904, to a UE, one or more configuration messages configuring the UE to transmit a plurality of UL reference signals during corresponding ones of the plurality of measurement instances.

The method 1900 further includes receiving 1906 A-AoA data and Z-AoA data corresponding to the UL reference signals from the NTN payload.

The method 1900 further includes determining 1908, at the base station, a location of the UE in the serving cell based on the A-AoA data and the Z-AoA data.

In some embodiments of the method 1900, the UL reference signals comprise SRSs.

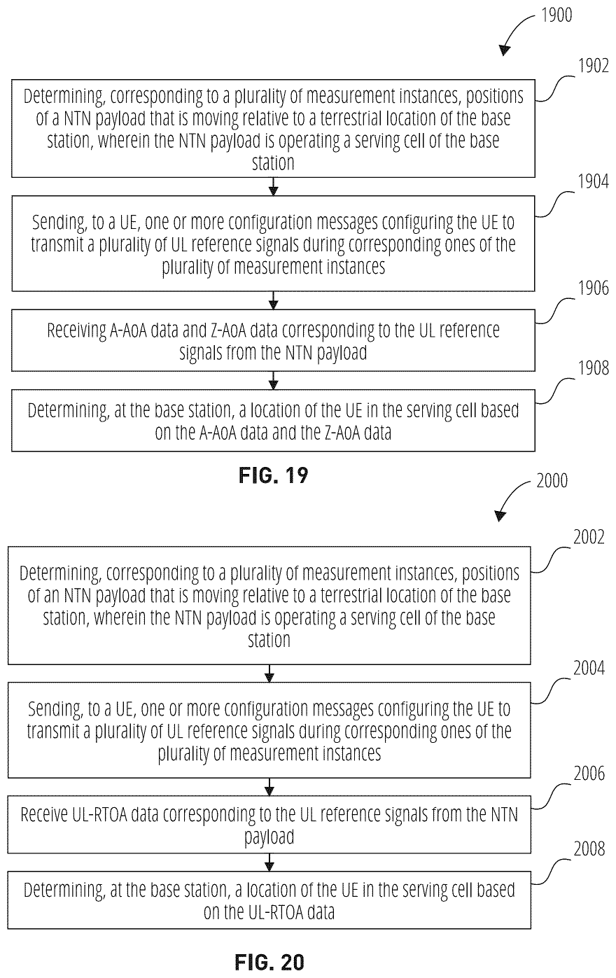

FIG. 20 illustrates a method 2000 of a base station, according to an embodiment. The method 2000 includes determining 2002, corresponding to a plurality of measurement instances, positions of an NTN payload that is moving relative to a terrestrial location of the base station, wherein the NTN payload is operating a serving cell of the base station.

The method 2000 further includes sending 2004, to a UE, one or more configuration messages configuring the UE to transmit a plurality of UL reference signals during corresponding ones of the plurality of measurement instances.

The method 2000 further includes receiving 2006 UL-RTOA data corresponding to the UL reference signals from the NTN payload.

The method 2000 further includes determining 2008, at the base station, a location of the UE in the serving cell based on the UL-RTOA data.

In some embodiments of the method 2000, the UL reference signals comprise SRSs.

In some embodiments, the method 2000 further includes receiving UL-SRS-RSRP data corresponding to the UL reference signals from the NTN payload, and the location of the UE in the serving cell is further determined based on the UL-SRS-RSRP data.

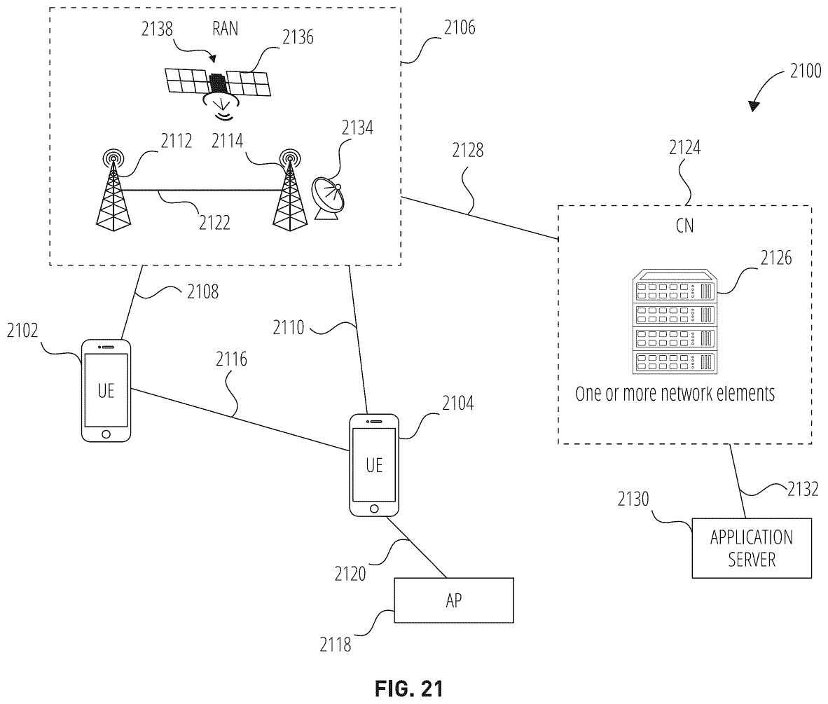

FIG. 21 illustrates an example architecture of a wireless communication system 2100, according to embodiments disclosed herein. The following description is provided for an example wireless communication system 2100 that operates in conjunction with the LTE system standards and/or 5G or NR system standards as provided by 3GPP technical specifications and other 3GPP documents.

As shown by FIG. 21, the wireless communication system 2100 includes UE 2102 and UE 2104 (although any number of UEs may be used). In this example, the UE 2102 and the UE 2104 are illustrated as smartphones (e.g., handheld touchscreen mobile computing devices connectable to one or more cellular networks), but may also comprise any mobile or non-mobile computing device configured for wireless communication.

The UE 2102 and UE 2104 may be configured to communicatively couple with a RAN 2106. In embodiments, the RAN 2106 may be NG-RAN, E-UTRAN, etc. The UE 2102 and UE 2104 utilize connections (or channels) (shown as connection 2108 and connection 2110, respectively) with the RAN 2106, each of which comprises a physical communications interface. The RAN 2106 can include one or more base stations (such as base station 2112 and the base station 2114) and/or other entities (e.g., a payload on the satellite 2136, which may operate a cell as directed by one of the base station 2112 and/or the base station 2114) that enable the connection 2108 and connection 2110. One or more non-terrestrial gateways 2134 may integrate the payload 2138 on the satellite 2136 into the RAN 2106, in the manner described in relation to the NTN architecture 100 of FIG. 1.

In this example, the connection 2108 and connection 2110 are air interfaces to enable such communicative coupling, and may be consistent with RAT(s) used by the RAN 2106, such as, for example, an LTE and/or NR. It is contemplated that the connection 2108 and connection 2110 may include, in some embodiments, service links between their respective UE 2102, UE 2104 and the payload 2138 of the satellite 2136.

In some embodiments, the UE 2102 and UE 2104 may also directly exchange communication data via a sidelink interface 2116.

The UE 2104 is shown to be configured to access an access point (AP) (shown as AP 2118) via connection 2120. By way of example, the connection 2120 can comprise a local wireless connection, such as a connection consistent with any IEEE 802.11 protocol, wherein the AP 2118 may comprise a Wi-Fi® router. In this example, the AP 2118 may be connected to another network (for example, the Internet) without going through a CN 2124.

In embodiments, the UE 2102 and UE 2104 can be configured to communicate using orthogonal frequency division multiplexing (OFDM) communication signals with each other, with the base station 2112, the base station 2114, and/or the payload 2138 of the satellite 2136 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2112 and/or the base station 2114 may be implemented as one or more software entities running on server computers as part of a virtual network.

In addition, or in other embodiments, the base station 2112 or base station 2114 may be configured to communicate with one another via interface 2122. In embodiments where the wireless communication system 2100 is an LTE system (e.g., when the CN 2124 is an EPC), the interface 2122 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 2100 is an NR system (e.g., when CN 2124 is a 5GC), the interface 2122 may be an Xn interface. An Xn interface is defined between two or more base stations that connect to 5GC (e.g., CN 2124). For example, the Xn interface may be between two or more gNBs that connect to 5GC, a gNB connecting to 5GC and an eNB, between two eNBs connecting to 5GC.

In embodiments where the wireless communication system 2100 is an LTE system (e.g., when the CN 2124 is an EPC), the interface 2122 may be an X2 interface. The X2 interface may be defined between two or more base stations (e.g., two or more eNBs and the like) that connect to an EPC, and/or between two eNBs connecting to the EPC.

The RAN 2106 is shown to be communicatively coupled to the CN 2124. The CN 2124 may comprise one or more network elements 2126, which are configured to offer various data and telecommunications services to customers/subscribers (e.g., users of UE 2102 and UE 2104) who are connected to the CN 2124 via the RAN 2106. The components of the CN 2124 may be implemented in one physical device or separate physical devices including components to read and execute instructions from a machine-readable or computer-readable medium (e.g., a non-transitory machine-readable storage medium). For example, the components of the CN 2124 may be implemented in one or more processors and/or one or more associated memories.

In embodiments, the CN 2124 may be an EPC, and the RAN 2106 may be connected with the CN 2124 via an S1 interface 2128. In embodiments, the S1 interface 2128 may be split into two parts, an S1 user plane (S1-U) interface, which carries traffic data between the base station 2112, base station 2114, and a serving gateway (S-GW), and the S1-MME interface, which is a signaling interface between the base station 2112 and/or the base station 2114 and mobility management entities (MMEs).

In embodiments, the CN 2124 may be a 5GC, and the RAN 2106 may be connected with the CN 2124 via an NG interface 2128. In embodiments, the NG interface 2128 may be split into two parts, an NG user plane (NG-U) interface, which carries traffic data between the base station 2112 and/or base station 2114 and a user plane function (UPF), and the S1 control plane (NG-C) interface, which is a signaling interface between the base station 2112 and/or the base station 2114 and access and mobility management functions (AMFs).

Generally, an application server 2130 may be an element offering applications that use internet protocol (IP) bearer resources with the CN 2124 (e.g., packet switched data services). The application server 2130 can also be configured to support one or more communication services (e.g., VOIP sessions, group communication sessions, etc.) for the UE 2102 and UE 2104 via the CN 2124. The application server 2130 may communicate with the CN 2124 through an IP communications interface 2132.

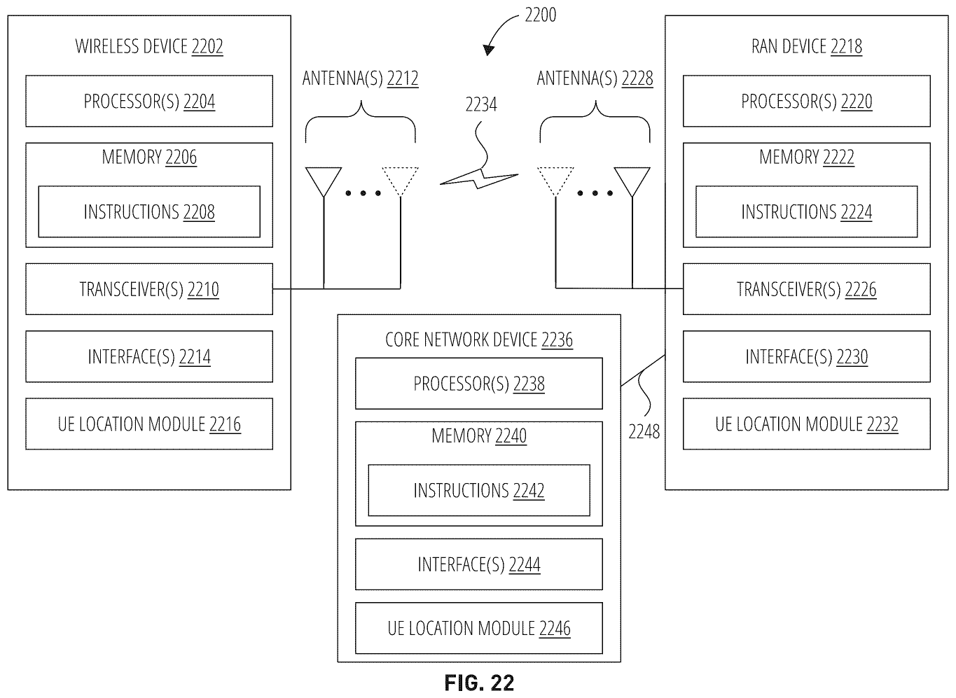

FIG. 22 illustrates a system 2200 for performing signaling 2234 between a wireless device 2202 and a RAN device 2218 connected to a core network of a CN device 2236, according to embodiments herein. The system 2200 may be a portion of a wireless communications system as herein described. The wireless device 2202 may be, for example, a UE of a wireless communication system. The RAN device 2218 may be, for example, a base station (e.g., an eNB or a gNB) of a wireless communication system that is a terrestrial base station. In the case of a RAN device 2218 that is a terrestrial base station, the RAN device 2218 may be in communication with a payload of a satellite that directly provides radio access connectivity to a UE, in the manner described herein. The CN device 2236 may be one or more devices making up a CN, as described herein.

The wireless device 2202 may include one or more processor(s) 2204. The processor(s) 2204 may execute instructions such that various operations of the wireless device 2202 are performed, as described herein. The processor(s) 2204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2202 may include a memory 2206. The memory 2206 may be a non-transitory computer-readable storage medium that stores instructions 2208 (which may include, for example, the instructions being executed by the processor(s) 2204). The instructions 2208 may also be referred to as program code or a computer program. The memory 2206 may also store data used by, and results computed by, the processor(s) 2204.

The wireless device 2202 may include one or more transceiver(s) 2210 that may include RF transmitter and/or receiver circuitry that use the antenna(s) 2212 of the wireless device 2202 to facilitate signaling (e.g., the signaling 2234) to and/or from the wireless device 2202 with other devices (e.g., the RAN device 2218) according to corresponding RATs. In some embodiments, the antenna(s) 2212 may include a moving parabolic antenna, an omni-directional phased-array antenna, or some other antenna suitable for communication with a payload on a satellite, (e.g., as described above in relation to the UE 108 of FIG. 1).

In an NTN case, the network device signaling 2234 may occur on a service link between the wireless device 2202 and a payload on a satellite and a feeder link between the payload of the satellite and the RAN device 2218 (e.g., as described in relation to FIG. 1).

The wireless device 2202 may include one or more antenna(s) 2212 (e.g., one, two, four, or more). For embodiments with multiple antenna(s) 2212, the wireless device 2202 may leverage the spatial diversity of such multiple antenna(s) 2212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 2202 may be accomplished according to precoding (or digital beamforming) that is applied at the wireless device 2202 that multiplexes the data streams across the antenna(s) 2212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2202 may implement analog beamforming techniques, whereby phases of the signals sent by the antenna(s) 2212 are relatively adjusted such that the (joint) transmission of the antenna(s) 2212 can be directed (this is sometimes referred to as beam steering).

The wireless device 2202 may include one or more interface(s) 2214. The interface(s) 2214 may be used to provide input to or output from the wireless device 2202. For example, a wireless device 2202 that is a UE may include interface(s) 2214 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2210/antenna(s) 2212 already described) that allow for communication between the UE and other devices and may operate according to known protocols (e.g., Wi-Fi®, Bluetooth®, and the like).

The wireless device 2202 may include a UE location module 2216. The UE location module 2216 may be implemented via hardware, software, or combinations thereof. For example, the UE location module 2216 may be implemented as a processor, circuit, and/or instructions 2208 stored in the memory 2206 and executed by the processor(s) 2204. In some examples, the UE location module 2216 may be integrated within the processor(s) 2204 and/or the transceiver(s) 2210. For example, the UE location module 2216 may be implemented by a combination of software components (e.g., executed by a DSP or a general processor) and hardware components (e.g., logic gates and circuitry) within the processor(s) 2204 or the transceiver(s) 2210.

The UE location module 2216 may be used for various aspects of the present disclosure, for example, aspects of FIG. 1 through FIG. 20. The UE location module 2216 is configured to, for example, provide a reported location of the UE to a RAN device 2218 when so instructed (e.g., by a RAN device 2218 that is a base station), etc.

The RAN device 2218 may include one or more processor(s) 2220. The processor(s) 2220 may execute instructions such that various operations of the RAN device 2218 are performed, as described herein. The processor(s) 2204 may include one or more baseband processors implemented using, for example, a CPU, a DSP, an ASIC, a controller, an FPGA device, another hardware device, a firmware device, or any combination thereof configured to perform the operations described herein.

The RAN device 2218 may include a memory 2222. The memory 2222 may be a non-transitory computer-readable storage medium that stores instructions 2224 (which may include, for example, the instructions being executed by the processor(s) 2220). The instructions 2224 may also be referred to as program code or a computer program. The memory 2222 may also store data used by, and results computed by, the processor(s) 2220.

The RAN device 2218 may include one or more transceiver(s) 2226 that may include RF transmitter and/or receiver circuitry that use the antenna(s) 2228 of the RAN device 2218 to facilitate signaling (e.g., the signaling 2234) to and/or from the RAN device 2218 with other devices (e.g., the wireless device 2202) according to corresponding RATs.

The RAN device 2218 may include one or more antenna(s) 2228 (e.g., one, two, four, or more). In embodiments having multiple antenna(s) 2228, the RAN device 2218 may perform MIMO, digital beamforming, analog beamforming, beam steering, etc., as has been described.

In an NTN case, the transceiver(s) 2226 and the antenna(s) 2228 may alternatively be present on a payload of a satellite associated with the base station.

The RAN device 2218 may include one or more interface(s) 2230. The interface(s) 2230 may be used to provide input to or output from the RAN device 2218. For example, a RAN device 2218 that is a base station may include interface(s) 2230 made up of transmitters, receivers, and other circuitry (e.g., other than the transceiver(s) 2226/antenna(s) 2228 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 2218 may include a UE location module 2232. The UE location module 2232 may be implemented via hardware, software, or combinations thereof. For example, the UE location module 2232 may be implemented as a processor, circuit, and/or instructions 2224 stored in the memory 2222 and executed by the processor(s) 2220. In some examples, the UE location module 2232 may be integrated within the processor(s) 2220 and/or the transceiver(s) 2226. For example, the UE location module 2232 may be implemented by a combination of software components (e.g., executed by a DSP or a general processor) and hardware components (e.g., logic gates and circuitry) within the processor(s) 2220 or the transceiver(s) 2226.

The UE location module 2232 may be used for various aspects of the present disclosure, for example, aspects of FIG. 1 through FIG. 20. The UE location module 2232 is configured to, for example, perform UE location mechanisms as these have been described herein with/for a wireless device 2202 that is a UE, etc.

The RAN device 2218 may communicate with the CN device 2236 via the interface 2248, which may be analogous to the interface 2128 of FIG. 21 (e.g., may be an S1 and/or NG interface, either of which may be split into user plane and control plane parts).

The CN device 2236 may include one or more processor(s) 2238. The processor(s) 2238 may execute instructions such that various operations of the CN device 2236 are performed, as described herein. The processor(s) 2238 may include one or more baseband processors implemented using, for example, a CPU, a DSP, an ASIC, a controller, an FPGA device, another hardware device, a firmware device, or any combination thereof configured to perform the operations described herein.

The CN device 2236 may include a memory 2240. The memory 2240 may be a non-transitory computer-readable storage medium that stores instructions 2242 (which may include, for example, the instructions being executed by the processor(s) 2238). The instructions 2242 may also be referred to as program code or a computer program. The memory 2240 may also store data used by, and results computed by, the processor(s) 2238.

The CN device 2236 may include one or more interface(s) 2244. The interface(s) 2244 may be used to provide input to or output from the CN device 2236. For example, a CN device 2236 may include interface(s) 2230 made up of transmitters, receivers, and other circuitry that enables the CN device 2236 to communicate with other equipment in the CN, and/or that enables the CN device 2236 to communicate with external networks, computers, databases, and the like for purposes of operations, administration, and maintenance of the CN device 2236 or other equipment operably connected thereto.

The CN device 2236 may include a UE location module 2246. The UE location module 2246 may be implemented via hardware, software, or combinations thereof. For example, the UE location module 2246 may be implemented as a processor, circuit, and/or instructions 2242 stored in the memory 2240 and executed by the processor(s) 2238. In some examples, the UE location module 2246 may be integrated within the processor(s) 2238. For example, the UE location module 2246 may be implemented by a combination of software components (e.g., executed by a DSP or a general processor) and hardware components (e.g., logic gates and circuitry) within the processor(s) 2238.

The UE location module 2246 may be used for various aspects of the present disclosure, for example, aspects of FIG. 1 through FIG. 20. The UE location module 2246 is configured to, for example, provide assistance data to a RAN device 2218 that is a base station, etc.

Embodiments contemplated herein include an apparatus comprising means to perform one or more elements of any of method 1200, method 1400, method 1600, method 1700, method 1900, and/or method 2000. This apparatus may be, for example, an apparatus of a base station (such as a RAN device 2218 that is a base station, as described herein).

Embodiments contemplated herein include one or more non-transitory computer-readable media comprising instructions to cause an electronic device, upon execution of the instructions by one or more processors of the electronic device, to perform one or more elements of any of method 1200, method 1400, method 1600, method 1700, method 1900, and/or method 2000. This non-transitory computer-readable media may be, for example, a memory of a base station (such as a memory 2222 of a RAN device 2218 that is a base station, as described herein).

Embodiments contemplated herein include an apparatus comprising logic, modules, or circuitry to perform one or more elements of any of method 1200, method 1400, method 1600, method 1700, method 1900, and/or method 2000. This apparatus may be, for example, an apparatus of a base station (such as a RAN device 2218 that is a base station, as described herein).

Embodiments contemplated herein include an apparatus comprising: one or more processors and one or more computer-readable media comprising instructions that, when executed by the one or more processors, cause the one or more processors to perform one or more elements of any of method 1200, method 1400, method 1600, method 1700, method 1900, and/or method 2000. This apparatus may be, for example, an apparatus of a base station (such as a RAN device 2218 that is a base station, as described herein).

Embodiments contemplated herein include a signal as described in or related to one or more elements of any of method 1200, method 1400, method 1600, method 1700, method 1900, and/or method 2000.

Embodiments contemplated herein include a computer program or computer program product comprising instructions, wherein execution of the program by a processing element is to cause the processing element to carry out one or more elements of any of method 1200, method 1400, method 1600, method 1700, method 1900, and/or method 2000. The processor may be a processor of a base station (such as a processor(s) 2220 of a RAN device 2218 that is a base station, as described herein). These instructions may be, for example, located in the processor and/or on a memory of the base station (such as a memory 2222 of a RAN device 2218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a base station, comprising:
determining positions of a plurality of non-terrestrial network (NTN) payloads operating a serving cell of the base station;
sending, to a user equipment (UE), a configuration message configuring the UE to report first receive (Rx) minus transmit (Tx) (Rx−Tx) values corresponding to the plurality of NTN payloads, the first Rx−Tx values to indicate lengths of first time periods between a time of transmission of an uplink (UL) reference signal from the UE and times of receipt of downlink (DL) reference signals at the UE;
determining second Rx−Tx values corresponding to the plurality of NTN payloads, wherein the second Rx−Tx values indicate lengths of second time periods between times of receipt the UL reference signal from the UE at the plurality of NTN payloads and times of transmission of the DL reference signals from respective ones of the plurality of NTN payloads;
receiving, from the UE, a measurement report comprising the first Rx−Tx values corresponding to the plurality of NTN payloads;
calculating distances of the UE from the positions of the plurality of NTN payloads using the first Rx−Tx values and the second Rx−Tx values; and
determining a location of the UE within the serving cell based on the positions of the plurality of NTN payloads and the distances of the UE from the positions of the plurality of NTN payloads.

2. The method of claim 1, wherein the second Rx−Tx values are further determined using drifting factors based on movements of the plurality of NTN payloads from the positions during the second time periods.

3. The method of claim 1, further comprising:
receiving, from the UE, a reported location of the UE within the serving cell;
determining that the reported location of the UE is not consistent with the location of the UE; and
restricting an operation of the UE with a network service for a geographical area corresponding to the reported location of the UE based on the determination that the reported location of the UE is not consistent with the location of the UE.

4. The method of claim 1, wherein the configuration message further configures the UE to use a positioning specific sounding reference signal (SRS), and wherein the UL reference signal comprises the positioning specific SRS.

5. The method of claim 1, wherein the DL reference signals comprise synchronization signal blocks (SSBs).

6. The method of claim 1, wherein the DL reference signals comprise channel state information reference signals (CSI-RSs).

7. The method of claim 1, wherein the configuration message comprises a radio resource control (RRC) configuration message.

8. The method of claim 1, wherein the measurement report further includes reference signal indexes that correspond to the DL reference signals to the first Rx−Tx values.

9. A method of a base station, comprising:
determining, corresponding to a plurality of measurement instances, positions of a non-terrestrial network (NTN) payload that is moving relative to a terrestrial location of the base station, wherein the NTN vehicle is operating a serving cell of the base station;
sending, to a user equipment (UE), one or more configuration messages configuring the UE to report first receive (Rx) minus transmit (Tx) (Rx−Tx) values corresponding to the plurality of measurement instances, the first Rx−Tx values to indicate lengths of first time periods between times of transmission of uplink (UL) reference signals from the UE during corresponding ones of the plurality of measurement instances and times of receipt of corresponding downlink (DL) reference signals at the UE;
determining second Rx−Tx values during the measurement instances, wherein the second Rx−Tx values indicate lengths of second time periods between times of receipt of the UL reference signals from the UE at the NTN payload and times of transmission of the corresponding DL reference signals from the NTN payload;
receiving, from the UE, the first Rx−Tx values;
calculating distances of the UE from the positions of the NTN payload during the measurement instances using the first Rx−Tx values and the second Rx−Tx values; and
determining a location of the UE within the serving cell based on the positions of the NTN payload during the measurement instances and the distances of the UE from the positions of the NTN payload during the measurement instances.

10. The method of claim 9, wherein the second Rx−Tx values are further determined using drifting factors based on movements of the NTN payloads from the positions during the second time periods.

11. The method of claim 9, further comprising:
receiving, from the UE, a reported location of the UE within the serving cell;
determining that the reported location of the UE is not consistent with the location of the UE; and
restricting an operation of the UE with a network service for a geographical area corresponding to the reported location of the UE based on the determination that the reported location of the UE is not consistent with the location of the UE.

12. The method of claim 9, wherein the one or more configuration messages further configure the UE to use positioning specific sounding reference signals (SRSs), and wherein the UL reference signals comprise the positioning specific SRSs.

13. The method of claim 9, wherein the DL reference signals comprise synchronization signal blocks (SSBs).

14. The method of claim 9, wherein the DL reference signals comprise channel state information reference signals (CSI-RSs).

15. The method of claim 9, wherein the one or more configuration messages comprise a radio resource control (RRC) configuration message.

16. The method of claim 9, wherein the one of the one or more configuration messages expressly indicates the plurality of measurement instances.

17. The method of claim 9, wherein one of the one or more configuration messages indicates a periodicity for the UE to use to determine the plurality of measurement instances.

18. A method of a base station, comprising:
determining positions of a plurality of non-terrestrial network (NTN) payloads operating a serving cell of the base station;
sending, to a user equipment (UE), a configuration message configuring the UE to transmit an uplink (UL) reference signal;
receiving azimuth angle of arrival (A-AoA) data and zenith angle of arrival (Z-AoA) data corresponding to the UL reference signal from the plurality of NTN payloads; and
determining, at the base station, a location of the UE in the serving cell based on the A-AoA data and the Z-AoA data.

19. The method of claim 18, wherein the UL reference signal comprises a sounding reference signal (SRS).

20-30. (canceled)
